(19) United States
(12) Patent Application Publication
(10) Pub. No.: US 2016/0126544 A1
(43) Pub. Date: May 5, 2016

(54) HIGH CAPACITY ELECTROACTIVE PARTICLES, AND ELECTRODES AND BATTERIES COMPRISING THE SAME

(71) Applicant: Jiang FAN, San Diego, CA (US)

(72) Inventor: Jiang FAN, San Diego, CA (US)

(21) Appl. No.: 14/527,743

(22) Filed: Oct. 29, 2014

(51) Int. Cl. H01M 4/48; H01M 4/36; H01M 4/62; H01M 4/583; H01M 10/052; H01M 4/60

(52) U.S. Cl. CPC H01M 4/48; H01M 10/052; H01M 4/602; H01M 4/622; H01M 4/583; H01M 4/366

(57) ABSTRACT

Provided herein is a coated electroactive particle, comprising i) a core comprising one or more electroactive materials, and optionally a binder; and ii) a polymeric overcoating on the surface of the core. Also provided herein is a coated electroactive particle, comprising i) a core that comprises an electroactive subparticle, an agglomerated particle comprising at least two electroactive subparticles and optionally a binder, or an agglomerated particle comprising at least one electroactive subparticle, at least one diluent subparticle, and optionally a binder; and ii) a polymeric overcoating on the surface of the core.

### CROSS REFERENCE TO RELATED APPLICATION

This application is a continuation of U.S. application Ser. No. 12/841,173, filed Jul. 22, 2010, which claims the benefit under 35 U.S.C. §119(e) of U.S. Provisional Application No. 61/232,431, filed Aug. 9, 2009, the disclosure of each of which is incorporated by reference herein in its entirety.

### FIELD

Provided herein is a coated electroactive particle, comprising i) a core comprising one or more electroactive materials, and optionally a binder; and ii) a polymeric overcoating on the surface of the core. Also provided herein is a coated electroactive particle, comprising i) a core that comprises an electroactive subparticle, an agglomerated particle comprising at least two electroactive subparticles and optionally a binder, or an agglomerated particle comprising at least one electroactive subparticle, at least one diluent subparticle, and optionally a binder; and ii) a polymeric overcoating on the surface of the core.

### BACKGROUND

There is great interest in developing rechargeable lithium batteries with higher energy capacity and longer cycle life for applications in, e.g., portable electronic devices, electric vehicles, and implantable medical devices. One way to increase the storage capacity of a rechargeable lithium battery is to replace the conventional anode with one constructed from an electrochemically active main group metal, such as Sn, Si, Al, Bi, Ge, or Pb. However, one of drawbacks of such an anode is its large volume change during charging/discharging cycles, which leads to pulverization, capacity fading, and insufficient cycle performance. For example, a silicon-based anode exihits a volume change by as much as 400% upon insertion and extraction of lithium during charging/discharging cycles (Boukamp et al., J. Electrochem. Soc. 1981, 128, 725-729). Therefore, there is a need for developing high capacity electroactive materials that do not pulverize during the charging and discharging processes with such a high volume varation, and/or has sufficient cycle performance.

### SUMMARY OF THE DISCLOSURE

Provided herein is a coated electroactive particle, comprising i) a core comprising one or more electroactive materials, and optionally a binder; and ii) a polymeric overcoating on the surface of the core. In certain embodiments, the binder is a polymeric binder. In certain embodiments, the binder is a polyamideimide. In certain embodiments, the binder is a polyimide. In certain embodiments, the polymeric overcoating is a polyamideimide. In certain embodiments, the polymeric overcoating is a polyimide.

Also provided herein is a coated electroactive particle, comprising i) a core that comprises an electroactive subparticle; an agglomerated particle comprising at least two electroactive subparticles and optionally a binder; or an agglomerated particle comprising at least one electroactive subparticle, at least one diluent subparticle, and optionally a binder; and ii) a polymeric overcoating on the surface of the core. In certain embodiments, the binder is a polymeric binder. In certain embodiments, the binder is a polyamideimide. In certain embodiments, the binder is a polyimide. In certain embodiments, the polymeric overcoating is a polyamideimide. In certain embodiments, the polymeric overcoating is a polyimide.

Further provided herein is a coated electroactive particle, comprising at least one electroactive subparticle and an organic polymer, wherein the outside surface of the electroactive subparticle is substantially coated with the organic polymer. In one embodiment, the coated electroactive particle further comprises at least one diluent subparticle, wherein the outside surface of the diluent subparticle is substantially coated with the organic polymer. In certain embodiments, the organic polymer is a polyamideimide. In certain embodiments, the organic polymer is a polyimide.

Additionally provided herein is an electrode that comprises i) a coated electroactive particle that comprises (a) a core comprising one or more electroactive materials, and optionally a binder; and (b) a polymeric overcoating on the surface of the core; ii) a current collector; and iii) optionally a binder. In certain embodiments, the binder is a polymeric binder. In certain embodiments, the binder is a polyamideimide. In certain embodiments, the binder is a polyimide. In certain embodiments, the polymeric overcoating is a polyamideimide. In certain embodiments, the polymeric overcoating is a polyimide.

Provided herein is an electrode that comprises i) a coated electroactive particle comprising (a) a core that comprises an electroactive subparticle; an agglomerated particle comprising at least two electroactive subparticles and optionally a binder; or an agglomerated particle comprising at least one electroactive subparticle, at least one diluent subparticle, and optionally a binder; and (b) a polymeric overcoating on the surface of the core; ii) a current collector; and iii) optionally a binder. In certain embodiments, the binder is a polymeric binder. In certain embodiments, the binder is a polyamideimide. In certain embodiments, the binder is a polyimide. In certain embodiments, the polymeric overcoating is a polyamideimide. In certain embodiments, the polymeric overcoating is a polyimide.

Provided herein is an electrode that comprises i) a coated electroactive particle comprising at least one electroactive subparticle and an organic polymer, wherein the outside surface of the electroactive subparticle is substantially coated with the organic polymer; ii) a current collector; and iii) optionally a binder. In one embodiment, the coated electroactive particle in the electrode further comprises at least one diluent subparticle, wherein the outside surface of the diluent subparticle is substantially coated with the organic polymer. In certain embodiments, the organic polymer is a polyamideimide. In certain embodiments, the organic polymer is a polyimide.

Provided herein is a lithium battery, which comprises i) an anode comprising a coated electroactive particle that comprises (a) a core comprising one or more electroactive materials, and optionally a binder; and (b) a polymeric overcoating on the surface of the core; ii) a cathode; and iii) electrolyte that separates the anode and cathode. In certain embodiments, the binder is a polymeric binder. In certain embodiments, the binder is a polyamideimide. In certain embodiments, the binder is a polyimide. In certain embodiments, the polymeric overcoating is a polyamideimide. In certain embodiments, the polymeric overcoating is a polyimide.

Provided herein is a lithium battery, which comprises i) an anode comprising a coated electroactive particle, which comprises (a) a core that comprises an electroactive subparticle; an agglomerated particle comprising at least two electroactive subparticles and optionally a binder; or an agglomerated particle comprising at least one electroactive subparticle, at least one diluent subparticle, and optionally a binder; ii) a cathode; and iii) electrolyte that separates the anode and cathode. In certain embodiments, the binder is a polymeric binder. In certain embodiments, the binder is a polyamideimide. In certain embodiments, the binder is a polyimide. In certain embodiments, the polymeric overcoating is a polyamideimide. In certain embodiments, the polymeric overcoating is a polyimide.

Provided herein is a lithium battery, which comprises i) an anode comprising a coated electroactive particle, which comprises at least one electroactive subparticle and an organic polymer, wherein the outside surface of the electroactive subparticle is substantially coated with the organic polymer; ii) a cathode; and iii) electrolyte that separates the anode and cathode. In one embodiment, the coated electroactive particle in the lithium battery comprises at least one diluent subparticle, wherein the outside surface of the diluent subparticle is substantially coated with the organic polymer. In certain embodiments, the organic polymer is a polyamideimide. In certain embodiments, the organic polymer is a polyimide.

Provided herein is a method for preparing the coated electroactive particles provided herein, which comprises the steps of: i) covering the surfaces of electroactive subparticles with a layer of a polymer in a solvent; and ii) curing the electroactive subparticles at an elevated temperature to form the coated electroactive particles. In one embodiment, the method further comprises the step of grinding the coated electroactive particles into predetermined particle sizes.

Provided herein is a method for preparing the coated electroactive particles provided herein, which comprises the steps of: i) covering the surfaces of electroactive subparticles with a layer of a mixture of precursors of a polymer in a solvent; and ii) curing the electroactive subparticles at an elevated temperature to form the coated electroactive particles. In one embodiment, the method further comprises the step of grinding the coated electroactive particles into predetermined particle sizes.

Provided herein is a method for preparing the coated electroactive particles provided herein, which comprises the steps of: i) mixing electroactive subparticles with a binder in a solvent to form electroactive agglomerated particles; ii) covering the surface of the electroactive agglomerated particles with a layer of a polymer in a solvent; and iii) curing the electroactive agglomerated particles at an elevated temperature to form the coated electroactive particles. In one embodiment, the method further comprises the step of grinding the coated electroactive particles into predetermined particle sizes.

Provided herein is a method for preparing the coated electroactive particles provided herein, which comprises the steps of: i) mixing electroactive subparticles with a binder to form electroactive agglomerated particles; ii) covering the surface of the electroactive agglomerated particles with a layer of a mixture of precursors of a polymer in a solvent; and iii) curing the electroactive agglomerated particles at an elevated temperature to form the coated electroactive particles. In one embodiment, the method further comprises the step of grinding the coated electroactive particles into predetermined particle sizes.

Provided herein is a method for preparing the coated electroactive particles provided herein, which comprises the steps of: i) mixing electroactive subparticles with a polymer in a solvent to form a slurry; ii) air-injecting the slurry to form particles; and iii) curing the particles from step ii) at an elevated temperature to form the coated electroactive particles. In one embodiment, the method further comprises the step of grinding the coated electroactive particles into predetermined particle sizes.

Provided herein is a method for preparing the coated electroactive particles provided herein, which comprises the steps of: i) mixing electroactive subparticles with a mixture of precursors of a polymer in a solvent to form a slurry; ii) air-injecting the slurry to form particles; and iii) curing the particles from step ii at an elevated temperature to form the coated electroactive particles. In one embodiment, the method further comprises the step of grinding the coated electroactive particles into predetermined particle sizes.

### BRIEF DESCRIPTION OF THE FIGURES

FIG. 1 is a schematic drawing of an agglomerated particle 11 comprising a single type of subparticles, e.g., subparticles of a single electroactive material 51.

FIG. 2 is a schematic drawing of an agglomerated particle 11 comprising two types of subparticles, e.g., subparticles of a first electroactive material 51 (clear circles) and subparticles of a second electroactive material 52 (shaded circles).

FIG. 3 is a cross-sectional view of a coated electroactive particle 1, comprising i) an electroactive agglomerated particle 11 (a big inner circle) that comprises subparticles of an electroactive material 51 (open circles) and optionally a binder 61; and ii) a polymeric overcoating 62 (dotted area) on the surface of the electroactive agglomerated particle 11.

FIG. 4 is a cross-sectional view of a coated electroactive particle 1, comprising an electroactive agglomerated particle 11 (a big circle) that comprises subparticles of an electroactive material 51 (open circles) and a polymeric binder 63 (dotted area within the big circle).

FIG. 5 is a cross-sectional view of a coated electroactive particle 1, comprising i) an electroactive agglomerated particle 11 (a big inner circle) that comprises subparticles of a first electroactive material 51 (open circles), subparticles of a second electroactive material 52 (shaded circles) or subparticles of a diluent material 53 (shaded circles), and optionally a binder 61; and ii) a polymeric overcoating 62 (dotted area) on the surface of the electroactive agglomerated particle 11.

FIG. 6 is a cross-sectional view of a coated electroactive particle 1, comprising an electroactive agglomerated particle 11 (a big circle) that comprises subparticles of a first electroactive material 51 (open circles), subparticles of a second electroactive material 52 (shaded circles) or subparticles of a diluent material 53 (shaded circles), and a polymeric binder 63 (dotted area within the big circle).

### DETAILED DESCRIPTION

To facilitate understanding of the disclosure set forth herein, a number of terms are defined below.

Generally, the nomenclature used herein and the laboratory procedures in electrochemistry, inorganic chemistry, polymer chemistry, organic chemistry, and others described herein are those well known and commonly employed in the art. Unless defined otherwise, all technical and scientific terms used herein generally have the same meaning as commonly understood by one of ordinary skill in the art to which this disclosure belongs.

The term “metal” refers to both metals and metalloids, including silicon and germanium. The phrase “a main group metal” is intended to include Sn, Si, Al, Bi, Ge, and Pb.

The term “anode” or “negative electrode” refers to an electrode where electrochemical oxidation occurs during discharging process. For example, an anode undergoes delithiation during discharging.

The term “cathode” or “positive electrode” refers to an electrode where electrochemical reduction occurs during discharging process. For example, a cathode undergoes lithiation during discharging.

The term “charging” refers to a process of providing electrical energy to an electrochemical cell.

The term “discharging” refers to a process of removing electrical energy from an electrochemical cell. In certain embodiments, discharging refers to a process of using the electrochemical cell to do useful work.

The term “electrochemically active,” “electrically active,” and “electroactive” are used interchangeably and refer to a material that is capable to incorporate lithium in its atomic lattice structure.

The term “lithiation” refers to a chemical process of inserting lithium into an electroactive material in an electrochemical cell. In certain embodiments, an electrode undergoes electrochemical reduction during lithiation process.

The term “delithiation” refers to a chemical process of removing lithium from an electroactive material in an electrochemical cell. In certain embodiments, an electrode undergoes electrochemical oxidation during delithiation process.

The term “about” or “approximately” means an acceptable error for a particular value as determined by one of ordinary skill in the art, which depends in part on how the value is measured or determined. In certain embodiments, the term “about” or “approximately” means within 1, 2, 3, or 4 standard deviations. In certain embodiments, the term “about” or “approximately” means within 50%, 20%, 15%, 10%, 9%, 8%, 7%, 6%, 5%, 4%, 3%, 2%, 1%, 0.5%, or 0.05% of a given value or range.

### Coated Electroactive Particle

In one embodiment, provided herein is a coated electroactive particle, comprising i) a core comprising one or more electroactive materials, and optionally a binder; and ii) a polymeric overcoating on the surface of the core. In certain embodiments, the surface of the electroactive agglomerate particle is substantially covered by the polymeric overcoating.

In another embodiment, provided herein is a coated electroactive particle, comprising i) a core that comprises an electroactive subparticle; an electroactive agglomerated particle comprising at least two electroactive subparticles and optionally a binder; or an electroactive agglomerated particle comprising at least one electroactive subparticle, at least one diluent subparticle, and optionally a binder; and ii) a polymeric overcoating on the surface of the core. In certain embodiments, the surface of the electroactive agglomerate particle is substantially covered by the polymeric overcoating.

In one embodiment, the coated electroactive particle provided herein comprises a core comprising an electroactive subparticle, and a polymeric overcoating on the surface of the core.

In another embodiment, the coated electroactive particle provided herein comprises a core that comprises an electroactive agglomerated particle comprising at least two electroactive subparticles and optionally a binder; and a polymeric overcoating on the surface of the core. In certain embodiments, the binder is polymeric binder. In certain embodiments, the polymeric binder is a polyamideimide. In certain embodiments, the polymeric binder is a polyimide.

In yet another embodiment, the coated electroactive particle provided herein comprises a core that comprises an electroactive agglomerated particle comprising at least one electroactive subparticle, at least one diluent subparticle, and optionally a binder; and a polymeric overcoating on the surface of the core. In certain embodiments, the binder is polymeric binder. In certain embodiments, the polymeric binder is a polyamideimide. In certain embodiments, the polymeric binder is a polyimide.

In certain embodiments, the polymeric overcoating is a polyamideimide. In certain embodiments the polymeric overcoating is a polyimide.

In certain embodiments, the polymeric binder and polymeric overcoating are different. In certain embodiments, the polymeric binder and polymeric overcoating are the same polymer. In certain embodiments, the polymeric binder and polymeric overcoating are the same polyamideimide. In certain embodiments, the polymeric binder and polymeric overcoating are the same polyimide.

In yet another embodiment, provided herein is a coated electroactive particle, comprising at least one electroactive subparticle and an organic polymer, wherein the outside surface of the electroactive subparticle is coated with the organic polymer. In one embodiment, the coated electroactive particle further comprises at least one diluent subparticle, wherein the outside surface of the diluent subparticle is coated with the organic polymer. In certain embodiments, the polymeric binder is a polyamideimide. In certain embodiments, the polymeric binder is a polyimide. Without being bound to any theory, in certain embodiments, the organic polymer functions both as a binder to hold the subparticles together to form an electroactive agglomerated particle and as a polymeric overcoating to coat the surface of the electroactive agglomerated particle.

In yet another embodiment, provided herein is a coated electroactive particle, comprising at least one electroactive subparticle and an organic polymer, wherein the outside surface of the electroactive subparticle is substantially coated with the organic polymer. In one embodiment, the coated electroactive particle further comprises at least one diluent subparticle, wherein the outside surface of the diluent subparticle is substantially coated with the organic polymer. In certain embodiments, the polymeric binder is a polyamideimide. In certain embodiments, the polymeric binder is a polyimide.

In certain embodiments, the coated electroactive particle provided herein is used as an electroactive material for a cathode. In certain embodiments, the coated electroactive particle provided herein is used as an electroactive material for an anode.

In certain embodiments, the electroactive subparticle is a subparticle containing an element of an electroactive main group metal. In certain embodiments, the electroactive subparticle is a subparticle of an electroactive main group metal. In certain embodiments, the electroactive subparticle is a subparticle of an electroactive main group metal oxide. In certain embodiments, the electroactive subparticle is a subparticle of an electroactive main group metal alloy. In certain embodiments, the main group metal is Sn, SI, Al, Bi, Ge, or Pb.

In certain embodiments, provided herein is a coated electroactive particle, comprising at least one electroactive subparticle containing an element of an electroactive main group metal, and a polyamideimide or polyimide, wherein the outside surface of the electroactive subparticle is coated with the polyamideimide or polyimide. In one embodiment, the coated electroactive particle further comprises at least one diluent subparticle, wherein the outside surface of the diluent subparticle is coated with the polyamideimide or polyimide.

In certain embodiments, provided herein is a coated electroactive particle, comprising at least one electroactive subparticle containing an element of an electroactive main group metal, and a polyamideimide or polyimide, wherein the outside surface of the electroactive subparticle is substantially coated with the polyamideimide or polyimide. In one embodiment, the coated electroactive particle further comprises at least one diluent subparticle, wherein the outside surface of the diluent subparticle is substantially coated with the polyamideimide or polyimide.

In certain embodiments, provided herein is a coated electroactive particle, comprising at least one electroactive subparticle containing Si element, and a polyamideimide or polyimide, wherein the outside surface of the electroactive subparticle is coated with the polyamideimide or polyimide. In one embodiment, the coated electroactive particle further comprises at least one diluent subparticle, wherein the outside surface of the diluent subparticle is coated with the polyamideimide or polyimide. In certain embodiments, the subparticle containing Si element is a Si subparticle. In certain embodiments, the subparticle containing Si element is a SiO subparticle.

In certain embodiments, provided herein is a coated electroactive particle, comprising at least one electroactive subparticle containing Si element, and a polyamideimide or polyimide, wherein the outside surface of the electroactive subparticle is substantially coated with the polyamideimide or polyimide. In one embodiment, the coated electroactive particle further comprises at least one diluent subparticle, wherein the outside surface of the diluent subparticle is substantially coated with the polyamideimide or polyimide. In certain embodiments, the subparticle containing Si element is a Si subparticle. In certain embodiments, the subparticle containing Si element is a SiO subparticle.

In certain embodiments, the diluent subparticle is a carbon subparticle, carbon nanotube (SWNT or MWNT), carbon nanofiber, Al subparticle, Ti subparticle, or a mixture thereof. In certain embodiments, the diluent subparticle is a carbon nanoparticle, including, but not limited to, carbon nanotube (SWNT or MWNT), carbon nanofiber, graphite nanoparticle, and disordered carbon nanoparticle; Al nanoparticle; Ti nanoparticle, or a mixture thereof.

In certain embodiments, the coated electroactive particle provided herein has various shapes, including, but not limited to, sphere, spheroid, platelet, fibril, or fiber. In certain embodiments, the coated electroactive particle is substantially spherical. In certain embodiments, the coated electroactive particle is spherical. In certain embodiments, the coated electroactive particle is spheroidal. In certain embodiments, the coated electroactive particle is in the shape of fiber.

In certain embodiments, the coated electroactive particle has an average particle size ranging from about 100 nm to about 100 μm, from about 500 nm to about 50 μm, from about 1 to about 20 μm, from about 2 to about 15 μm, from about 3 to about 10 μm, or from about 3 to about 5 μm. In certain embodiments, the coated electroactive particle has an average particle size of about 1 μm, about 2 μm, about 3 μm, about 4 μm, about 5 μm, about 6 μm, about 7 μm, about 8 μm, about 9 μm, or about 10 μm. In certain embodiments, the coated electroactive particle has an average particle size of about 3 μm. In certain embodiments, the coated electroactive particle has an average particle size of about 4 μm. In certain embodiments, the coated electroactive particle has an average particle size of about 5 μm.

In certain embodiments, the coated electroactive particle in the shape of sphere or platelet has an average particle size ranging from about 100 nm to about 100 μm, from about 500 nm to about 50 μm, from about 1 to about 20 μm, from about 2 to about 15 μm, from about 3 to about 10 μm, or from about 3 to about 5 μm. In certain embodiments, the coated electroactive particle in the shape of sphere or platelet has an average particle size of about 1 μm, about 2 μm, about 3 μm, about 4 μm, about 5 μm, about 6 μm, about 7 μm, about 8 μm, about 9 μm, or about 10 μm. In certain embodiments, the coated electroactive particle in the shape of sphere or platelet has an average particle size of about 3 μm. In certain embodiments, the coated electroactive particle in the shape of sphere or platelet has an average particle size of about 4 μm. In certain embodiments, the coated electroactive particle in the shape of sphere or platelet has an average particle size of about 5 μm.

In certain embodiments, the coated electroactive particle in the shape of spheroid has an average particle size ranging from about 100 nm to about 100 μm, from about 500 nm to about 50 μm, from about 1 to about 20 μm, from about 2 to about 15 μm, from about 3 to about 10 μm, or from about 3 to about 5 μm. In certain embodiments, the coated electroactive particle in the shape of spheroid has an average particle size of about 1 μm, about 2 μm, about 3 μm, about 4 μm, about 5 μm, about 6 μm, about 7 μm, about 8 μm, about 9 μm, or about 10 μm. In certain embodiments, the coated electroactive particle in the shape of spheroid has an average particle size of about 3 μm. In certain embodiments, the coated electroactive particle in the shape of spheroid has an average particle size of about 4 μm. In certain embodiments, the coated electroactive particle in the shape of spheroid has an average particle size of about 5 μm.

In certain embodiments, the coated electroactive particle in the shape of fibril or fiber has an average diameter ranging from about 1 to about 500 nm, from about 2 to about 250 nm, from about 5 to about 100 nm, from about 10 to about 50 nm, or from about 20 to about 40 nm. In certain embodiments, the coated electroactive particle in the shape of fibril or fiber has an average diameter of about 5 nm, about 10 nm, about 15 nm, about 20 nm, about 25 nm, about 30 nm, about 35 nm, about 40 nm, about 45 nm, about 50 nm, about 60 nm, about 70 nm, about 80 nm, about 90 nm, or about 100 nm. In certain embodiments, the coated electroactive particle in the shape of fibril or fiber has an average diameter of about 20 to about 40 nm. In certain embodiments, the coated electroactive particle in the shape of fibril or fiber has an average diameter of about 25 nm.

In certain embodiments, the coated electroactive particle in the shape of fibril or fiber has an average length ranging from about 50 nm to about 1,000 μm, from about 50 nm to about 100 μm, or from about 50 nm to about 10 μm. In certain embodiments, the coated electroactive particle in the shape of fibril or fiber has an average length of about 50 nm, about 100 nm, about 250 nm, about 500 nm, about 1 μm, about 2 μm, about 5 μm, about 10 μm, about 20 μm, or about 100 μm.

The particle sizes and particle size distributions of the particle and subparticle provided herein can be determined using any methods known to by one of ordinary skill in the art, including, but not limited to, laser light scattering and microscopic imaging.

In certain embodiments, the coated electroactive particle has an average surface area ranging from about 0.1 to about 100 m²/g, from about 1 to about 50 m²/g, from about 2 to about 20 m²/g, from about 5 to about 20 m²/g, from about 2 to about 15 m²/g, from about 2 to about 10 m²/g, or from about 10 to about 15 m²/g.

In certain embodiments, the coated electroactive particle is porous. In certain embodiments, the coated electroactive particle has an average porosity as measured by density, ranging from about 0.1 to about 5 g/cm³, from about 0.2 to about 3 g/cm³, from about 0.5 to about 2 g/cm³, or from about 0.5 to about 1 g/cm³. In certain embodiments, the coated electroactive particle has porosity of about 0.5, about 1, about 1.5, about 2, about 2.5, about 3, about 3.5, about 4, about, 4.5, or about 5 g/cm³.

In certain embodiments, the coated electroactive particles have such particle size distribution that 10% of the coated electroactive particles have a particle size of about 0.05 μm, about 0.1 μm, or about 1 μm; and 90% of the coated electroactive particles have a particle size of about 100 μm, about 50 μm, about 20 μm, about 10 μm, or about 5 μm. In certain embodiments the coated electroactive particles have such particle size distribution that 10% of the coated electroactive particles have a particle size of 1 μm and 90% of the coated electroactive particles have a particle size of 10 μm.

In certain embodiments, the coated electroactive particle has a particle size ranging from about 100 nm to about 500 μm, from about 200 nm to about 200 μm, from about 500 nm to about 100 μm, from about 1 to about 50 μm, from about 10 to about 50 μm, from about 10 to about 40 μm, from about 10 to about 30 μm, or from about 10 to about 20 μm. In certain embodiments, the coated electroactive particle has a particle size in the range from about 1 to about 50 μm.

In certain embodiments, the volume change of the coated electroactive particle during a charging/discharging cycle is no more than about 400%, no more than about 350%, no more than about 300%, no more than about 250%, no more than about 200%, no more than about 150%, no more than 100%, no more than about 50%, no more than about 25%, or no more than about 10%.

In certain embodiments, the amount of volume change of the coated electroactive particle during a charging/discharging cycle can be altered by addition of at least one diluent subparticle as described herein. In certain embodiments, the coated electroactive particle provided herein comprises from about 5 to about 95%, from about 10 to about 90%, from about 20 to about 80%, from about 30 to about 75%, or from about 40 to about 60% of the electroactive subparticle by weight, and about 95 to about 5%, from about 90 to about 10%, from about 80 to about 20%, from about 70 to about 30%, or from about 60 to about 40% of the diluent subparticle by weight. In certain embodiments, the agglomerated particle in the coated electroactive particle provided herein comprises about 30%, about 35%, about 40%, about 45%, about 50%, about 55%, about 60%, about 65%, or about 70% of the electroactive subparticles by weight, and about 70%, about 65%, about 60%, about 55%, about 50%, about 45%, about 40%, about 35%, or about 30% of the diluent subparticles by weight. In certain embodiments, the agglomerated particle in the coated electroactive particle provided herein comprises about 50% of the electroactive subparticles by weight, and about 50% of the diluent subparticles by weight.

Without being bound to any theory, one advantage of the coated electroactive particle provided herein is that the electroactive particle can be used to make electrodes using conventional processing techniques, such as reverse roll coating or doctor blade coating. Without being bound to any theory, another advantage of the coated electroactive particle provided herein is that, in manufacturing an electrode, the use of the coated electroactive particles provided herein eliminates the high-temperature curing process typically associated with polyimides, which often leads to the oxidation of the current collector (e.g., a Cu foil) of the electrode,

### Electroactive Agglomerated Particle

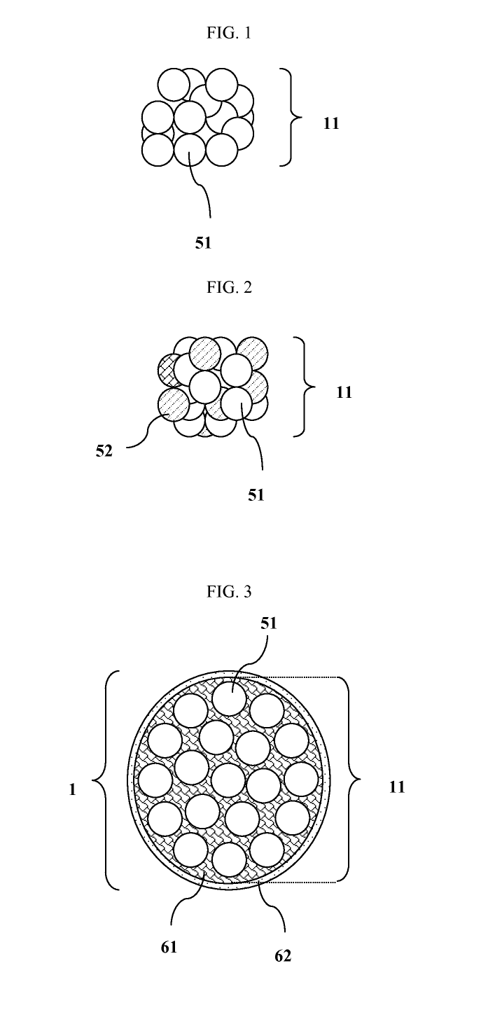

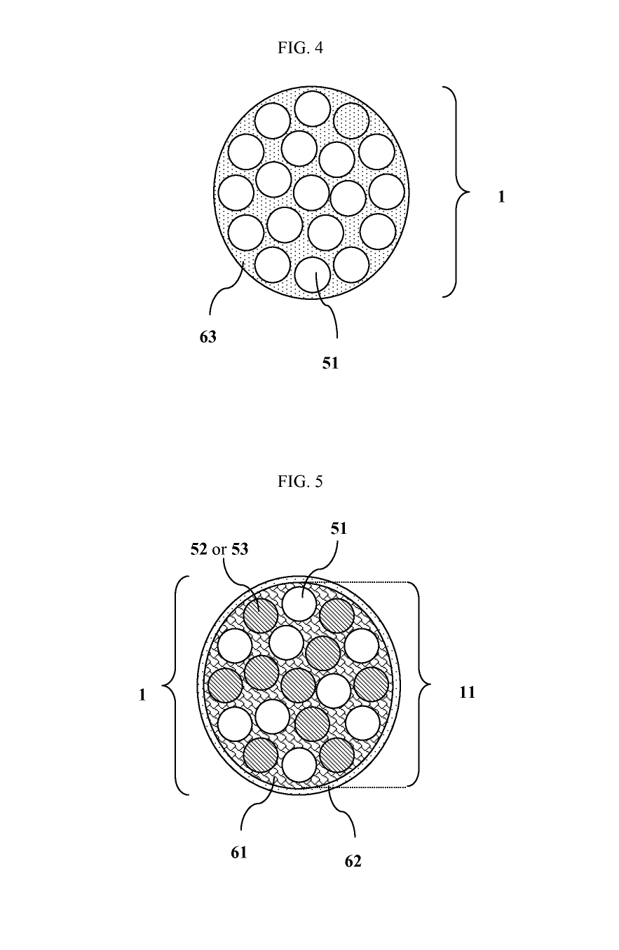

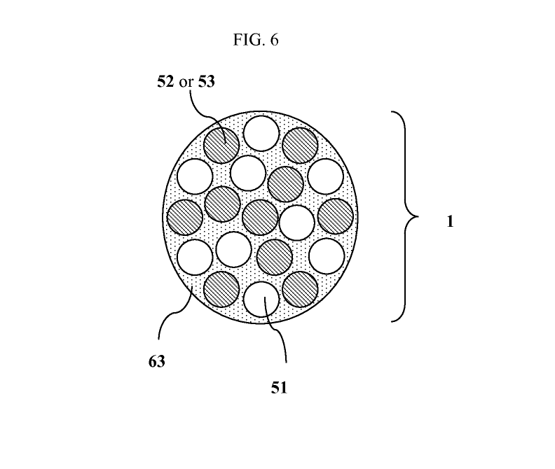

In one embodiment, the electroactive agglomerated particle provided herein comprises one or more electroactive materials and optionally a binder. In certain embodiments, the agglomerated particle provided herein comprises one electroactive material, shown in FIG. 1. In certain embodiments, the electroactive agglomerated particle provided herein comprises two electroactive materials, as shown in FIG. 2.

In another embodiment, the electroactive agglomerated particle provided herein comprises at least one type of electroactive subparticles and optionally a binder. In certain embodiments, the agglomerated particle provided herein comprises a single type of electroactive subparticles as shown in FIG. 1.

In yet another embodiment, the electroactive agglomerated particle provided herein comprises at least two different types of electroactive subparticles. In certain embodiments, the electroactive agglomerated particle provided herein comprises two different types of electroactive subparticles as shown in FIG. 2. In one embodiment, the at least two types of subparticles each comprise a different electroactive material, wherein the first type of electroactive subparticles comprises a first electroactive material, and the second type of electroactive subparticles comprise a second electroactive material.

In certain embodiments, the electroactive agglomerated particles provided herein further comprises at least one diluent or diluent subparticle.

In yet another embodiment, the agglomerated particle provided herein comprises at least one electroactive subparticle, at least one diluent subparticle, and optionally a binder.

In one embodiment, the electroactive agglomerated particle provided herein further comprises at least one diluent or diluent subparticle. In certain embodiments, the amount of the at least one diluent or diluent subparticle in the electroactive agglomerated particle is ranging from about 0.01 to about 20% by weight, from about 0.05 to about 10% by weight, from about 1 to about 10% by weight, from about 0.1 to about 5% by weight, from about 1 to about 5% by weight, from about 0.2 to about 2% by weight, from about 1 to about 2% by weight, from about 0.3 to about 1.5% by weight, or from about 0.5 to about 1% by weight of the electroactive agglomerated particle. In certain embodiments, the amount of the at least one diluent or diluent subparticle in the electroactive agglomerated particle is ranging from about 1 to about 10% by weight, from about 1 to about 5% by weight, from about 1 to about 2% by weight, from about 0.3 to about 1.5% by weight, or from about 0.5 to about 1% by weight of the electroactive agglomerated particle. In certain embodiments, the amount of the at least one diluent or diluent subparticle in the electroactive agglomerated particle is about 0.3% by weight, about 0.5% by weight, about 0.7% by weight, about 0.9% by weight, about 1% by weight, about 1.1% by weight, about 1.2% by weight, about 1.3% by weight, about 1.4% by weight, about 1.5% by weight, about 1.6% by weight, about 1.7% by weight, about 1.8% by weight, about 1.9% by weight, about 2% by weight, about 2.5% by weight, about 3% by weight, about 3.5% by weight, about 4% by weight, about 4.5% by weight, or about 5% by weight of the electroactive agglomerated particle.

Suitable diluent materials include, but are not limited to, acetylene black, ketjen black, furnace black, lamp black, carbon (including, but not limited to, disordered carbon, carbon black, graphite, carbon nanotubes, single-walled nanotubes, multi-wall nanotubes, and carbon fibers), aluminum, aluminum oxide, chromium, chromium boride, chromium carbide, copper, cobalt, gold, hafnium boride, hafnium carbide, hafnium nitride, iron, lead, molybdenum, molybdenum boride, molybdenum carbide, molybdenum silicide, molybdenum trioxide, nickel, platinum, silica (silicon dioxide), silver, SnCoC, titanium, titanium boride, titanium carbide, titanium dioxide, titanium nitride, titanium silicide, tungsten, tungsten boride, tungsten carbide, tungsten silicide, tungsten trioxide, vanadium silicide, zirconium boride, zirconium carbide, zirconium nitride, zirconium oxide, and combinations thereof.

In certain embodiments, the diluent or diluent subparticle is a carbon subparticle. In certain embodiments, the diluent or diluent subparticle is a carbon nanoparticle. In certain embodiments, the diluent or diluent subparticle is a disordered carbon nanoparticle. In certain embodiments, the diluent or diluent subparticle is a graphite nanoparticle. In certain embodiments, the diluent or diluent subparticle is a carbon nanotube. In certain embodiments, the diluent or diluent subparticle is a carbon SWNT. In certain embodiments, the diluent or diluent subparticle is a carbon MWNT. In certain embodiments, the diluent or diluent subparticle is a carbon nanofiber.

In certain embodiments, the diluent or diluent subparticle is an Al nanoparticle or Ti nanoparticle.

In certain embodiments, the diluent or diluent subparticle used herein has various shapes, including, but not limited to, sphere, fibril, fiber, or platelet. In certain embodiments, the diluent or diluent subparticle used herein is substantially spherical. In certain embodiments, the diluent or diluent subparticle used herein is spherical.

In certain embodiments, the diluent or diluent subparticle used herein has an average particle size ranging from about 10 nm to about 100 μm, from about 10 nm to about 10 μm, from about 20 nm to about 5 μm, from about 20 nm to about 1 μm, from about 20 to about 500, from about 50 to about 500 nm, from about 50 to about 400 nm, from about 50 to about 200 nm, or from about 100 to about 200 nm. In certain embodiments, the diluent or diluent subparticle used herein has an average particle size ranging about 50 nm, about 100 nm, about 150 nm, about 200 nm, about 300 nm, about 400 nm, about 500 nm, about 1 μm, about 2 μm, about 5 μm, or about 10 μm. In certain embodiments, the diluent or diluent subparticle used herein has an average particle size ranging from about 10 to about 500 nm, from about 10 to about 200 nm, or from about 20 to about 100 nm.

In another embodiment, the electroactive agglomerated particle provided herein further comprises a binder. Suitable binders include, but are not limited to, asphalt pitch, pitch coke, petroleum coke, sugars (e.g., sucrose), coal tar, fluoranthene, pyrene, chrysene, phenanthrene, anthracene, naphthalin, fluorine, biphenyl, acenephthene, solid ionic conductors, polymeric binders, and mixtures thereof.

In certain embodiments, the binder is asphalt pitch, pitch coke, petroleum coke, sugars, coal tar, fluoranthene, pyrene, chrysene, phenanthrene, anthracene, naphthalin, fluorine, biphenyl, or acenephthene, wherein the binder is subsequently carbonized, in one embodiment, in an inert gas atmosphere, so that the subparticles are coated with and bound together by a carbonized layer. In one embodiment, the amount of the carbonized binder in the electroactive agglomerated particle is ranging from about 0.1 to about 20%, from about 0.5 to about 10%, or from about 1 to about 5% of the weight of the electroactive agglomerated particles. In certain embodiments, the inert gas that is used in the carbonization process is argon, nitrogen, or carbon dioxide. In certain embodiments, the carbonization is performed at a temperature ranging from about 250 to about 1,000° C., from about 300 to about 900° C., from about 400 to about 800° C., or from about 500 to about 700° C.

In certain embodiments, the binder is a solid ionic conductor. In certain embodiments, the binder is a solid ionic conductor selected from the group consisting of Li₃PO₄; a mixture of lithium nitride and lithium phosphate; a mixture of lithium phosphorus oxynitride and lithium phosphate; Li_{1+x+y}(Al, Ga)ₓ(Ti, Ge)₂₋ₓSi_{y}P₃-yO₁₂, where 0≦x≦1 and 0≦y≦1; and LiₓSi_{y}M_{z}OᵥN_{w}, where 0.3≦x≦0.46, 0.05.≦y≦0.15, 0.016.≦z≦0.05, 0.42≦v<0.05, 0≦x≦0.029, and M is selected from the group consisting of Nb, Ta, and W.

In certain embodiments, the binder is a polymeric binder. Suitable polymeric binders include, but are not limited to, polyamideimides, polyimides, polytetrafluoroethylene (PTFE), carboxymethyl cellulose (CMC), polyvinylidene fluoride (PVDF), polyvinyl alcohol (PVA), styrene butadiene rubber (SBR), and mixtures thereof. In certain embodiments, the polymeric binder is a polyamideimide. In certain embodiments, the polymeric binder is a polyimide. In certain embodiments, the polymeric binder is a carboxymethyl cellulose.

In certain embodiments, the binder is a crosslinkable polymeric binder. Suitable crosslinkable polymeric binders include, but are not limited to, polybenzophenones, polyacrylates, polyvinyls, polystyrenes, polysulfones, 2,3-dihydrofuran-containing polymers, carboxymethyl celluloses (CMC), polyamideimides, polyimides, styrene-containing copolymers, and mixtures thereof. In certain embodiments, the crosslinkable polymeric binder is a polyamideimide. In certain embodiments, the crosslinkable polymeric binder is a polyimide. In certain embodiments, the crosslinkable polymeric binder is a carboxymethyl cellulose.

In certain embodiments, the crosslinkable polymeric binder is a thermally crosslinkable polymeric binder. Suitable thermally crosslinkable polymeric binders include, but are not limited to, carboxymethyl celluloses (CMC), polyamideimides, polyimides, and mixtures thereof. In certain embodiments, the thermally crosslinkable polymeric binder is a polyamideimide. In certain embodiments, the thermally crosslinkable polymeric binder is a polyimide. In certain embodiments, the thermally crosslinkable polymeric binder is a carboxymethyl cellulose.

In certain embodiments, the crosslinkable polymeric binder is a photo-crosslinkable polymeric binder. Suitable photo-crosslinkable polymeric binders include, but are not limited to, polybenzophenones, polyacrylates, polyvinyls, polystyrenes, polysulfones, 2,3-dihydrofuran-containing polymers, styrene-containing copolymers, and mixtures thereof.

In certain embodiments, the binder is a crosslinked polymeric binder. Suitable crosslinked polymeric binders include, but are not limited to, polybenzophenones, polyacrylates, polyvinyls, polystyrenes, polysulfones, 2,3-dihydrofuran-containing polymers, carboxymethyl celluloses (CMC), polyamideimides, polyimides, styrene-containing copolymers, and mixtures thereof. In certain embodiments, the crosslinked polymeric binder is a polyamideimide. In certain embodiments, the crosslinked polymeric binder is a polyimide. In certain embodiments, the crosslinked polymeric binder is a carboxymethyl cellulose.

In certain embodiments, the crosslinked polymeric binder is a thermally crosslinked polymeric binder. Suitable thermally crosslinked polymeric binders include, but are not limited to, carboxymethyl celluloses (CMC), polyamideimides, polyimides, and mixtures thereof. In certain embodiments, the thermally crosslinked polymeric binder is a polyamideimide. In certain embodiments, the thermally crosslinked polymeric binder is a polyimide. In certain embodiments, the thermally crosslinked polymeric binder is a carboxymethyl cellulose.

In certain embodiments, the crosslinked polymeric binder is a photo-crosslinked polymeric binder. Suitable photo-crosslinked polymeric binders include, but are not limited to, polybenzophenones, polyacrylates, polyvinyls, polystyrenes, polysulfones, 2,3-dihydrofuran-containing polymers, styrene-containing copolymers, and mixtures thereof.

In certain embodiments, the polymeric binder is formed from its precursors via polymerization on the surface of the subparticles provided herein. In certain embodiments, the precursors of a polymer are monomers of the polymer. In certain embodiments, the polyamideimide as a polymeric binder is formed from a polyanhydride and a polyamine via polymerization on the surfaces of the subparticles. In certain embodiments, the polyimide as a polymeric binder is formed from a polyanhydride and a polyamine via polymerization on the surfaces of the subparticles. In certain embodiments, the precursors of a polymer are crosslinkable polymers. In certain embodiments, the polyamideimide as a polymeric binder is formed from a polyamideimide via crosslinking on the surface of the subparticles provided herein. In certain embodiments, the polyimide as a polymeric binder is formed from a polyimide via crosslinking on the surface of the subparticle provided herein.

In certain embodiments, the amount of the binder in the electroactive agglomerated particle is ranging from about 0.1% to about 30%, from about 0.5% to about 20%, from about 1% to about 15%, from about 1% to about 10%, from about 1% to about 5%, or from about 2% to about 10% of the weight of the electroactive agglomerated particle.

In certain embodiments, a conductive polymer is also added to the polymeric binder to increase the conductivity of the electroactive agglomerated particles. Suitable conductive polymers include, but are not limited to, polythiophene, poly(3-hexylthiophene), poly(2-acetylthiophene), polybenzothiopnene, poly(2,5-dimethylthiophene), poly(2-ethylthiophene), poly(3-carboxylic ethyl thiophene), polythiopheneacetonitrile, poly(3,4-ethylenedioxythiophene), polyisothianaphthene, polypyrrole, polyaniline, polyparaphenylene, and mixtures thereof. In certain embodiments, the conductive polymer is added to the polymeric binder in an amount ranging from about 1 to about 40%, from about 2 to about 20%, from about 3 to about 15%, or from about 5 to about 10% of the total weight of the polymeric binder and conductive polymer. In certain embodiments, the conductive polymer is added to the polymeric binder first before contacting with the electroactive agglomerated particles.

In certain embodiments, the electroactive agglomerated particle provided herein is a micrometer-sized particle. Without being bound to any theory, such a micrometer-sized particle can increase the particle flowability, and manufacturability of end products, e.g., electrodes for a battery. In certain embodiments, the electroactive agglomerated particle has an average particle size ranging from about 0.1 to about 100 μm, from about 0.5 to about 50 μm, from about 0.5 to about 20 μm, from about 1 to about 20 μm, from about 1 to about 10 μm, from about 2 to about 20 μm, from about 2 to about 10 μm, from about 3 to about 10 μm, from about 5 to about 12 μm, from about 6 to about 10 μm, from about 1 to about 5 μm, from about 2 to about 5 μm, or from about 3 to about 5 μm. In certain embodiments, the electroactive agglomerated particle has an average particle size of about 1 μm, about 2 μm, about 3 μm, about 4 μm, about 5 μm, about 6 μm, about 7 μm, about 8 μm, about 9, or about 10 μm. In certain embodiments, the electroactive agglomerated particle has an average particle size of about 3 μm. In certain embodiments, the electroactive agglomerated particle has an average particle size of about 4 μm. In certain embodiments, the electroactive agglomerated particle has an average particle size of about 5 μm.

In certain embodiments, the electroactive agglomerated particle has an average surface area ranging from about 0.1 to about 100 m²/g, from about 1 to about 50 m²/g, from about 2 to about 20 m²/g, from about 5 to about 20 m²/g, from about 2 to about 15 m²/g, from about 2 to about 10 m²/g, or from about 10 to about 15 m²/g.

In certain embodiments, the electroactive agglomerated particle is porous. In certain embodiments, the electroactive agglomerated particle has porosity as measured by density, ranging from about 0.1 to about 10 g/cm³, from about 0.2 to about 5 g/cm³, from about 0.5 to about 4 g/cm³, or from about 1 to about 3 g/cm³. In certain embodiments, the electroactive agglomerated particle has porosity of about 0.5, about 1, about 1.5, about 2, about 2.5, about 3, about 3.5, about 4, about, 4.5, or about 5 g/cm³.

In certain embodiments, the electroactive agglomerated particles have such particle size distribution that 10% of the electroactive agglomerated particles have a particle size of about 0.05 μm, about 0.1 μm, or about 1 μm; and 90% of the electroactive agglomerated particles have a particle size of about 100 μm, about 50 μm, about 20 μm, about 10 μm, or about 5 μm. In certain embodiments, the electroactive agglomerated particles have such particle size distribution that 10% of the electroactive agglomerated particles have a particle size of 1 μm and 90% of the electroactive agglomerated particles have a particle size of 10 μm.

In certain embodiments, the electroactive agglomerated particle has a particle size ranging from about 100 nm to about 500 μm, from about 200 nm to about 200 μm, from about 500 nm to about 100 μm, from about 1 to about 50 μm, from about 10 to about 50 μm, from about 10 to about 40 μm, from about 10 to about 30 μm, or from about 10 to about 20 μm. In certain embodiments, the electroactive agglomerated particle has a particle size in the range from about 1 to about 50 μm.

In certain embodiments, the electroactive agglomerated particles are coated to provide additional desired chemical and/or physical properties, such as chemical inertness (by coating with metal oxides, such as TiO₂, MoO₃, WO₃, Al₂O₃, or ZnO) or electrical conductivity (by coating with, e.g., ionic conductors or carbon). In certain embodiments, the electroactive agglomerated particles are coated with a metal oxide by mixing the electroactive agglomerated particles with the metal oxide, e.g., in a grinder. In certain embodiments, the electroactive agglomerated particles are coated with a metal oxide by mixing the electroactive agglomerated particles with a solution of polytitanic acid, polytungstic acid, polymolybdic acid, polytitanic acid peroxide, polytungstic acid peroxide, polymolybdic acid peroxide, or a mixture thereof, to form the corresponding metal oxide upon dehydration.

In certain embodiments, the electroactive agglomerated particles are coated with carbon by thermal vapor deposition (CVD), as described in U.S. Pat. App. Pub. No. 2003/025711, the disclosure of which is incorporated herein by reference in its entirety.

In yet another embodiment, the electroactive agglomerated particle provided herein comprises a first and second electroactive materials, and optionally a binder.

In certain embodiments, the electroactive agglomerated particle provided herein comprises from about 30 to about 95% by weight of the first electroactive material and from about 70 to about 5% by weight of the second electroactive material, with the proviso that the total is no greater than 100%.

In certain embodiments, the electroactive agglomerated particle provided herein comprises from about 30 to about 95% by weight of the subparticles of the first electroactive material and from about 70 to about 5% by weight of the subparticles of the second electroactive material, with the proviso that the total is no greater than 100%.

In certain embodiments, the electroactive agglomerated particle provided herein comprises from about 30 to about 95% by weight of the first electroactive material, from about 70 to about 5% by weight of the second electroactive material, and from about 0.1 to about 5% by weight of the binder; with the proviso that the total is no greater than 100%.

In certain embodiments, the electroactive agglomerated particle provided herein comprises from about 30 to about 95% by weight of the subparticles of the first electroactive material, from about 70 to about 5% by weight of the subparticles of the second electroactive material, and from about 0.1 to about 5% by weight of the binder; with the proviso that the total is no greater than 100%.

In one embodiment, the electroactive agglomerated particle comprises from about 1 to about 99%, from about 30 to about 95%, from about 50 to about 90%, from about 60% to about 90%, from about 60% to about 80%, from about 65% to about 80%, from about 70% to about 80%, or from about 80% to 90% by weight of the subparticles (type 1) of the first electroactive material; and from about 99 to about 1%, from about 70 to about 5%, from about 50 to about 10%, from about 40 to about 10%, from about 40 to about 20%, from about 35 to about 20%, from about 30 to about 20%, or from about 20 to about 10% by weight of the second electroactive material, with the proviso that the total is no greater than 100%.

In one embodiment, the electroactive agglomerated particle comprises from about 50 to about 90% by weight of the first electroactive material and from about 50 to about 10% by weight of the second electroactive material with the proviso that the total is no greater than 100%.

In another embodiment, the electroactive agglomerated particle comprises from about 50 to about 90% by weight of the subparticles of the first electroactive material and from about 50 to about 10% by weight of the subparticles of the second electroactive material with the proviso that the total is no greater than 100%.

In yet another embodiment, the electroactive agglomerated particle comprises from about 60 to about 90% by weight of the first electroactive material and from about 40 to about 10% by weight of the second electroactive material with the proviso that the total is no greater than 100%.

In yet another embodiment, the electroactive agglomerated particle comprises from about 60 to about 90% by weight of the subparticles of the first electroactive material and from about 40 to about 10% by weight of the subparticles of the second electroactive material with the proviso that the total is no greater than 100%.

In yet another embodiment, the electroactive agglomerated particle comprises from about 60 to about 80% by weight of the first electroactive material and from about 40 to about 20% by weight of the second electroactive material with the proviso that the total is no greater than 100%.

In still another embodiment, the electroactive agglomerated particle comprises from about 60 to about 80% by weight of the subparticles of the first electroactive material and from about 40 to about 20% by weight of the subparticles of the second electroactive material with the proviso that the total is no greater than 100%.

In one embodiment, the electroactive agglomerated particle comprises from about 30 to about 95% by weight of the first electroactive material, from about 70 to about 5% by weight of the second electroactive material, and from about 0.1 to about 5% by weight of the binder(s). In another embodiment, the electroactive agglomerated particle comprises from about 50 to about 90% by weight of the first electroactive material and from about 50 to about 10% by weight of the second electroactive material, and from about 0.1 to about 5% by weight of the binder(s). In yet another embodiment, the electroactive agglomerated particle comprises from about 60 to about 90% by weight of the first electroactive material and from about 40 to about 10% by weight of the second electroactive material, and from about 0.1 to about 5% by weight of the binder(s). In yet another embodiment, the electroactive agglomerated particle comprises from about 70 to about 90% by weight of the first electroactive material and from about 30 to about 10% by weight of the second electroactive material, and from about 0.1 to about 5% by weight of the binder(s). Nevertheless, the total amount of all the ingredients in the agglomerates should equal to 100%.

In one embodiment, the electroactive agglomerated particle comprises from about 30 to about 95% by weight of the subparticles (type 1) of the first electroactive material, from about 70 to about 5% by weight of the subparticles (type 2) of the second electroactive material, and from about 0.1 to about 5% by weight of the binder(s). In another embodiment, the electroactive agglomerated particle comprises from about 50 to about 90% by weight of the subparticles (type 1) of the first electroactive material and from about 50 to about 10% by weight of the subparticles (type 2) of the second electroactive material, and from about 0.1 to about 5% by weight of the binder(s). In yet another embodiment, the electroactive agglomerated particle comprises from about 60 to about 90% by weight of the subparticles of the first electroactive material and from about 40 to about 10% by weight of the subparticles of the second electroactive material, and from about 0.1 to about 5% by weight of the binder(s). In yet another embodiment, the electroactive agglomerated particle comprises from about 70 to about 90% by weight of the subparticles of the first electroactive material and from about 30 to about 10% by weight of the subparticles of the second electroactive material, and from about 0.1 to about 5% by weight of the binder(s). Nevertheless, the total amount of all the ingredients in the agglomerates should equal to 100%.

In certain embodiments, the electroactive agglomerated particle provided herein comprises from about 30 to about 95% by weight of the first electroactive material, from about 70 to about 5% by weight of the second electroactive material, and from about 0.1 to about 5% by weight of the binder; with the proviso that the total is no greater than 100%.

In certain embodiments, the electroactive agglomerated particle provided herein comprises from about 30 to about 95% by weight of the subparticles of the first electroactive material, from about 70 to about 5% by weight of the subparticles of the second electroactive material, and from about 0.1 to about 5% by weight of the binder; with the proviso that the total is no greater than 100%.

Each type of the electroactive subparticles used herein can have various shapes, including, but not limited to, sphere, spheroid, fibril, fiber, or platelet. In certain embodiments, the electroactive subparticles used herein are substantially spherical. In certain embodiments, the electroactive subparticles used herein are spherical. In certain embodiments, the electroactive subparticles used herein are spheroidal.

In certain embodiments, each type of the electroactive subparticles in the electroactive agglomerated particles independently has an average particle size ranging from about 1 to about 500 nm, from about 1 to about 200 nm, or from about 2 to about 100 nm.

In certain embodiments, at least one type of the electroactive subparticles used herein is coated to provide additional desired chemical and/or physical properties, such as chemical inertness (by coating with metal oxides, such as TiO₂, MoO₃, WO₃, Al₂O₃, or ZnO) or electrical conductivity (by coating with, e.g., ionic conductors or carbon). In certain embodiments, at least one type of the electroactive subparticles used herein is coated with a metal oxide by mixing the electroactive subparticles with the metal oxide, e.g., in a grinder. In certain embodiments, at least one type of the electroactive subparticles used herein is coated with a metal oxide by mixing the electroactive subparticles with a solution of polytitanic acid, polytungstic acid, polymolybdic acid, polytitanic acid peroxide, polytungstic acid peroxide, or polymolybdic acid peroxide, which forms the corresponding metal oxide upon dehydration.

In certain embodiments, at least one type of the electroactive subparticles used herein is coated with a carbonized carbon layer. In certain embodiments, at least one type of the electroactive subparticles used herein is first treated with a binder, including, but not limited to, asphalt pitch, pitch coke, petroleum coke, a sugar, coal tar, fluoranthene, pyrene, chrysene, phenanthrene, anthracene, naphthalin, fluorine, biphenyl, acenephthene, or a mixture thereof; and subsequently carbonized, in one embodiment, in an inert gas atmosphere, to form carbonized carbon layer on the surface of the electroactive subparticles.

In certain embodiments, at least one type of the electroactive subparticles used herein is coated with carbon by thermal vapor deposition (CVD), as described in U.S. Pat. App. Pub. No. 2003/025711, the disclosure of which is incorporated herein by reference in its entirety.

a. Electroactive Agglomerated Particle for a Anode

In one embodiment, provided herein is an electroactive agglomerated particle comprising at least one electroactive material for an anode and optionally a binder.

In certain embodiments, the electroactive material is an electroactive main group metal. In certain embodiments, the electroactive material is an electroactive main group metal oxide. In certain embodiments, the electroactive material is an electroactive main group metal alloy. In certain embodiments, the main group metal is Sn, SI, Al, Bi, Ge, or Pb.

In another embodiment, provided herein is an electroactive agglomerated particle comprising subparticles of an electroactive material for an anode, and optionally a binder.

In certain embodiments, the electroactive subparticle is a subparticle containing an element of an electroactive main group metal. In certain embodiments, the electroactive subparticle is a subparticle of an electroactive main group metal. In certain embodiments, the electroactive subparticle is a subparticle of an electroactive main group metal oxide. In certain embodiments, the electroactive subparticle is a subparticle of an electroactive main group metal alloy. In certain embodiments, the main group metal is Sn, SI, Al, Bi, Ge, or Pb.

In certain embodiments, provided herein is an electroactive agglomerated comprising at least one electroactive subparticle containing an element of an electroactive main group metal, and a polyamideimide or polyimide, wherein the outside surface of the electroactive subparticle is coated with the polyamideimide or polyimide. In one embodiment, the electroactive agglomerated particle further comprises at least one diluent subparticle, wherein the outside surface of the diluent subparticle is coated with the polyamideimide or polyimide.

In certain embodiments, provided herein is an electroactive agglomerated particle, comprising at least one electroactive subparticle containing an element of an electroactive main group metal, and a polyamideimide or polyimide, wherein the outside surface of the electroactive subparticle is substantially coated with the polyamideimide or polyimide. In one embodiment, the electroactive agglomerated particle further comprises at least one diluent subparticle, wherein the outside surface of the diluent subparticle is substantially coated with the polyamideimide or polyimide.

In certain embodiments, provided herein is an electroactive agglomerated particle, comprising at least one electroactive subparticle containing Si element, and a polyamideimide or polyimide, wherein the outside surface of the electroactive subparticle is coated with the polyamideimide or polyimide. In one embodiment, the electroactive agglomerated particle further comprises at least one diluent subparticle, wherein the outside surface of the diluent subparticle is coated with the polyamideimide or polyimide. In certain embodiments, the subparticle containing Si element is a Si subparticle. In certain embodiments, the subparticle containing Si element is a SiO subparticle.

In certain embodiments, provided herein is an electroactive agglomerated particle, comprising at least one electroactive subparticle containing Si element, and a polyamideimide or polyimide, wherein the outside surface of the electroactive subparticle is substantially coated with the polyamideimide or polyimide. In one embodiment, the electroactive agglomerated particle further comprises at least one diluent subparticle, wherein the outside surface of the diluent subparticle is substantially coated with the polyamideimide or polyimide. In certain embodiments, the subparticle containing Si element is a Si subparticle. In certain embodiments, the subparticle containing Si element is a SiO subparticle.

b. Electroactive Agglomerated Particle for a Cathode

In one embodiment, provided herein is an electroactive agglomerated particle comprising at least two electroactive materials.

In another embodiment, provided herein is an electroactive agglomerated particle comprising at least two types of electroactive subparticles. In one embodiment, the at least two types of subparticles each comprise a different electroactive material. In another embodiment, the first type is subparticles of a first electroactive material, and the second type is subparticles of a second electroactive material.

In yet another embodiment, provided herein is an electroactive agglomerated particle comprising a first and second electroactive materials.

In yet another embodiment, provided herein is an electroactive agglomerated particle comprising subparticles of a first electroactive material and subparticles of a second electroactive material.

In yet another embodiment, provided herein is an electroactive agglomerated particle comprising a first electroactive material and LiNi_{1-a-b}AlₐCo_{b}O₂, where a and b are each as defined herein.

In yet another embodiment, provided herein is an electroactive agglomerated particle comprising a first electroactive material and LiNi_{1-a-b}AlₐCo_{b}O₂ subparticles, where a and b are each as defined herein; wherein the LiNi_{1-a-b}AlₐCo_{b}O₂ subparticles are embedded in the electroactive agglomerated particle.

In still another embodiment, provided herein is an electroactive agglomerated particle comprising subparticles of a first electroactive material and LiNi_{1-a-b}AlₐCo_{b}O₂, where a and b are each as defined herein; wherein the subparticles of the first electroactive material are embedded in the electroactive agglomerated particle.

In one embodiment, the electroactive agglomerated particle provided herein comprises LiFePO₄ or LiMnPO₄ (type 1), and LiNi_{c}Co_{1-c}O₂ (type 2), wherein c is no less than 0 and no greater than 1; or ranging from about 0.05 to about 0.95, from about 0.1 to about 0.90, from about 0.2 to about 0.5, or from about 0.2 to about 0.4. In one embodiment, c is ranging from about 0.2 to about 0.5 or from about 0.2 to about 0.4, or about 0.3.

In another embodiment, the electroactive agglomerated particle provided herein comprises subparticles of LiFePO₄ or LiMnPO₄ (type 1) and subparticles of LiNi_{c}Co_{1-c}O₂ (type 2), wherein c is as defined herein.

In yet another embodiment, the electroactive agglomerated particle provided herein comprises LiFePO₄ or LiMnPO₄ (type 1), and V₂O₅ (type 2).

In yet another embodiment, the electroactive agglomerated particle provided herein comprises subparticles of LiFePO₄ or LiMnPO₄ (type 1) and subparticles of V₂O₅ (type 2).

In yet another embodiment, the electroactive agglomerated particle provided herein comprises LiFePO₄ or LiMnPO₄ (type 1), and LiNi_{1-a-b}AlₐCo_{b}O₂ (type 2), where a and b are each as defined herein.

In yet another embodiment, the electroactive agglomerated particle provided herein comprises subparticles of LiFePO₄ or LiMnPO₄ (type 1) and subparticles of LiNi_{1-a-b}AlₐCo_{b}O₂ (type 2), where a and b are each as defined herein.

In one embodiment, the electroactive agglomerated particle provided herein comprises LiFePO₄ or LiMnPO₄, LiNi_{c}Co_{1-c}O₂, and optionally a binder, wherein c is as defined herein. In another embodiment, the electroactive agglomerated particle provided herein comprises subparticles of LiFePO₄ or LiMnPO₄, subparticles of LiNi_{c}Co_{1-c}O₂, and optionally a binder, wherein c is as defined herein. In certain embodiments, the binder is coal tar. In certain embodiments, the binder is a polymeric binder. In certain embodiments, the binder is a crosslinkable polymer. In certain embodiments, the binder is a polyamideimide. In certain embodiments, the binder is a polyimide. In certain embodiments, the binder is carboxymethyl cellulose (CMC).

In certain embodiments, the electroactive agglomerated particle provided herein comprises LiFePO₄ or LiMnPO₄, LiN_{ic}C_{o1-c}O₂, and coat tar, wherein c is as defined herein. In certain embodiments, the electroactive agglomerated particle provided herein comprises LiFePO₄ or LiMnPO₄, LiN_{ic}C_{o1-c}O₂, and a polyamideimide or polyimide, wherein c is as defined herein.

In certain embodiments, the electroactive agglomerated particle provided herein comprises subparticles of LiFePO₄ or LiMnPO₄, subparticles of LiN_{ic}C_{o1-c}O₂, and coat tar, wherein c is as defined herein. In certain embodiments, the electroactive agglomerated particle provided herein comprises subparticles of LiFePO₄ or LiMnPO₄, subparticles of LiN_{ic}C_{o1-c}O₂, and a polyamideimide or polyimide, wherein c is as defined herein.

In yet another embodiment, the electroactive agglomerated particle provided herein comprises LiFePO₄ or LiMnPO₄, V₂O₅, and optionally a binder. In yet another embodiment, the electroactive agglomerated particle provided herein comprises subparticles of LiFePO₄ or LiMnPO₄, subparticles of V₂O₅, and optionally a binder. In certain embodiments, the binder is coal tar. In certain embodiments, the binder is a polymeric binder. In certain embodiments, the binder is a crosslinkable polymer. In certain embodiments, the binder is a polyamideimide. In certain embodiments, the binder is a polyimide. In certain embodiments, the binder is carboxymethyl cellulose (CMC).

In certain embodiments, the electroactive agglomerated particle provided herein comprises LiFePO₄ or LiMnPO₄, V₂O₅, and coat tar. In certain embodiments, the electroactive agglomerated particle provided herein comprises LiFePO₄ or LiMnPO₄, V₂O₅, and a polyamideimide or polyimide.

In certain embodiments, the electroactive agglomerated particle provided herein comprises subparticles of LiFePO₄ or LiMnPO₄, subparticles of V₂O₅, and coat tar. In certain embodiments, the electroactive agglomerated particle provided herein comprises subparticles of LiFePO₄ or LiMnPO₄, subparticles of V₂O₅, and a polyamideimide or polyimide.

In yet another embodiment, the electroactive agglomerated particle provided herein comprises LiFePO₄ or LiMnPO₄, LiNi_{1-a-b}AlₐCo_{b}O₂, and optionally a binder, wherein a and b are each as defined herein. In still another embodiment, the electroactive agglomerated particle provided herein comprises subparticles of LiFePO₄ or LiMnPO₄, subparticles of LiNi_{1-a-b}AlₐCo_{b}O₂, and optionally a binder, wherein a and b are each as defined herein. In certain embodiments, the binder is coal tar. In certain embodiments, the binder is a polymeric binder. In certain embodiments, the binder is a crosslinkable polymer. In certain embodiments, the binder is a polyamideimide. In certain embodiments, the binder is a polyimide. In certain embodiments, the binder is carboxymethyl cellulose (CMC).

In certain embodiments, the electroactive agglomerated particle provided herein comprises LiFePO₄ or LiMnPO₄, LiNi_{1-a-b}AlₐCo_{b}O₂, and coat tar, wherein a and b are each as defined herein. In certain embodiments, the electroactive agglomerated particle provided herein comprises LiFePO₄, LiNi_{1-a-b}AlₐCo_{b}O₂ or LiMnPO₄, and a polyamideimide or polyimide, wherein a and b are each as defined herein.

In certain embodiments, the electroactive agglomerated particle provided herein comprises subparticles of LiFePO₄ or LiMnPO₄, subparticles of LiNi_{1-a-b}AlₐCo_{b}O₂, and coat tar, wherein a and b are each as defined herein. In certain embodiments, the electroactive agglomerated particle provided herein comprises subparticles of LiFePO₄, subparticles of LiNi_{1-a-b}AlₐCo_{b}O₂ or LiMnPO₄, and a polyamideimide or polyimide, wherein a and b are each as defined herein.

In certain embodiments, the electroactive agglomerated particle provided herein comprises from about 30 to about 95% by weight of LiFePO₄ or LiMnPO₄, and from about 70 to about 5% by weight of LiNi_{1-a-b}AlₐCo_{b}O₂, with the proviso that the total is no greater than 100%; where a and b are each as defined herein.

In certain embodiments, the electroactive agglomerated particle provided herein comprises from about 30 to about 95% by weight of LiFePO₄ or LiMnPO₄ subparticles, and from about 70 to about 5% by weight of LiNi_{1-a-b}AlₐCo_{b}O₂ subparticles, with the proviso that the total is no greater than 100%; where a and b are each as defined herein.

In certain embodiments, the electroactive agglomerated particle provided herein comprises LiFePO₄ or LiMnPO₄, LiNi_{1-a-b}AlₐCo_{b}O₂, and at least one diluent, where a and b are each as defined herein; wherein the diluent is selected from the group consisting of carbon, in one embodiment, graphite, disordered carbon, carbon nanotubes (SWNTs or MWNTs), and carbon nanofibers; Al, Ti, and mixtures thereof. In one embodiment, the diluent is a carbon nanoparticle.

In certain embodiments, the electroactive agglomerated particle provided herein comprises LiFePO₄ or LiMnPO₄ subparticles, LiNi_{1-a-b}AlₐCo_{b}O₂ subparticles, and at least one diluent subparticle, where a and b are each as defined herein; wherein the diluent subparticle is selected from the group consisting of carbon nanoparticles, in one embodiment, graphite nanoparticle, disordered carbon nanoparticle, carbon nanotubes (SWNTs or MWNTs), and carbon nanofibers; Al subparticles, Ti subparticles, and mixtures thereof. In one embodiment, the diluent subparticle is a carbon nanoparticle.

In certain embodiments, the electroactive agglomerated particle provided herein comprises from about 30 to about 95% by weight of LiFePO₄ or LiMnPO₄, from about 70 to about 5% by weight of LiNi_{1-a-b}AlₐCo_{b}O₂, and from about 0.1 to about 5% by weight of carbon; with the proviso that the total is no greater than 100%; where a and b are each as defined herein.

In certain embodiments, the electroactive agglomerated particle provided herein comprises from about 30 to about 95% by weight of LiFePO₄ or LiMnPO₄ subparticles, from about 70 to about 5% by weight of LiNi_{1-a-b}AlₐCo_{b}O₂ subparticles, and from about 0.1 to about 5% by weight of carbon subparticles; with the proviso that the total is no greater than 100%; where a and b are each as defined herein.

In certain embodiments, the electroactive agglomerated particle provided herein comprises from about 60 to about 90% by weight of LiFePO₄ or LiMnPO₄, from about 40 to about 10% by weight of LiNi_{1-a-b}AlₐCo_{b}O₂, and from about 0.1 to about 5% by weight of carbon; with the proviso that the total is no greater than 100%; where a and b are each as defined herein.

In certain embodiments, the electroactive agglomerated particle provided herein comprises from about 60 to about 90% by weight of LiFePO₄ or LiMnPO₄ subparticles, from about 40 to about 10% by weight of LiNi_{1-a-b}AlₐCo_{b}O₂ subparticles, and from about 0.1 to about 5% by weight of carbon subparticles; with the proviso that the total is no greater than 100%; where a and b are each as defined herein.

In certain embodiments, the electroactive agglomerated particle provided herein comprises from about 65 to about 80% by weight of LiFePO₄ or LiMnPO₄, from about 35 to about 20% by weight of LiNi_{1-a-b}AlₐCo_{b}O₂, and from about 1 to about 2% by weight of carbon; with the proviso that the total is no greater than 100%; where a and b are each as defined herein.

In certain embodiments, the electroactive agglomerated particle provided herein comprises from about 65 to about 80% by weight of LiFePO₄ or LiMnPO₄ subparticles, from about 35 to about 20% by weight of LiNi_{1-a-b}AlₐCo_{b}O₂ subparticles, and from about 1 to about 2% by weight of carbon subparticles; with the proviso that the total is no greater than 100%; where a and b are each as defined herein.

Without being bound to any theory, one advantage of the electroactive agglomerated particle is that the electroactive particle can be used to make electrodes using conventional processing techniques, such as reverse roll coating or doctor blade coating. Without being bound to any theory, another advantage is that one of the two electroactive materials in the electroactive agglomerated particle can enhance the electrical or ionic conductivity of the other without reducing specific capacity. For example, with the electroactive agglomerated particle comprising LiFePO₄ and LiAlNiCoO₂, the voltage behaviors of both the LiFePO₄ and LiAlNiCoO₂ materials are retained, so that the electroactive agglomerated particle behaves as a superposition of the two.

In one embodiment, the first electroactive material is a lithium compound. In one embodiment, the first electroactive material is a lithium phosphate compound. In another embodiment, the first electroactive material is LiMPO₄, wherein M is a transition metal. In yet another embodiment, M is a transition metal selected from the group consisting of Ti, V, Cr, Mn, Fe, Co, and Ni. In yet another embodiment, the first electroactive material is LiFePO₄. In yet another embodiment, the first electroactive material is LiMnPO₄. In yet another embodiment, the first electroactive material is LiVPO₄. In yet another embodiment, the first electroactive material is AM^{a}_{1-d}M^{b}_{d}PO₄, wherein A is Li, Na, or a mixture thereof; M^{a} is Fe, Co, Mn, or a mixture thereof; M^{b} is Mg, Ca, Zn, Ni, Co, Cu, Al, B, Cr, Nb, or a mixture thereof; and d is ranging from about 0.01 to about 0.99, from about 0.01 to about 0.5, from about 0.01 to about 0.30, or from about 0.01 to about 0.15. In yet another embodiment, the first electroactive material is LiM^{a}_{1-d}M^{b}_{d}PO₄, wherein M^{a}, M^{b}, and d are each as defined herein. In still another embodiment, the first electroactive material is NaM^{a}_{1-d}M^{b}_{d}PO₄, wherein M^{a}, M^{b}, and d are each as defined herein.

In another embodiment, the second electroactive material is a metal oxide. In one embodiment, the second electroactive material is selected from the group consisting of LiCoO₂, LiNiCoO₂, LiNi_{c}Co_{1-c}O₂, wherein c is from about 0.05 to about 0.95, from about 0.1 to about 0.90, from about 0.2 to about 0.5, or from about 0.2 to about 0.4, Li(NiMnCo)_{1/3}O₂, Li(NiMn)_{1/2}O₂, LiV₂O₅, and mixtures thereof. In yet another embodiment, the second electroactive material is LiCoO₂. In yet another embodiment, the second electroactive material is LiNiCoO₂.

In yet another embodiment, the second electroactive material is LiNi_{c}Co_{1-c}O₂, wherein c is ranging from about 0.05 to about 0.95, from about 0.1 to about 0.90, from about 0.2 to about 0.5, or from about 0.2 to about 0.4. In yet another embodiment, the second electroactive material is LiNi_{c}Co_{1-c}O₂, wherein c is from about 0.2 to about 0.5, from about 0.2 to about 0.4, or about 0.3. In yet another embodiment, the second electroactive material is Li(NiMnCo)_{1/3}O₂. In yet another embodiment, the second electroactive material is Li(NiMn)_{1/2}O₂. In yet another embodiment, the second electroactive material is LiV₂O₅.

In yet another embodiment, the second electroactive material is LiNiₑMn_{f}Co_{1-e-f}O₂, wherein e and f are each independently ranging from about 0 to about 0.95, from about 0.01 to about 0.9, from about 0.05 to about 0.80, from about 0.1 to about 0.5, or from about 0.2 to about 0.4, and the sum of e and f is less than 1. In yet another embodiment, the second electroactive material is LiNiₑMn_{f}Co_{1-e-f}O₂, wherein e and f are 0.33.

In still another embodiment, the second electroactive material is LiNi_{1-a-b}AlₐCo_{b}O₂, wherein a is from about 0.01 to about 0.9, from about 0.01 to about 0.7, from about 0.01 to about 0.5, from about 0.01 to about 0.4, from about 0.01 to about 0.3, from about 0.01 to about 0.2, or from about 0.01 to about 0.1; and b is from about 0.01 to about 0.9, from about 0.01 to about 0.7, from about 0.01 to about 0.5, from about 0.01 to about 0.4, from about 0.01 to about 0.3, from about 0.01 to about 0.2, or from about 0.01 to about 0.1; with the proviso that the sum of a and b is less than 1. In certain embodiments, a is from about 0.01 to about 0.5. In certain embodiments, a is from about 0.01 to about 0.1. In certain embodiments, b is from about 0.01 to about 0.9. In certain embodiments, b is from about 0.01 to about 0.2. In certain embodiments, a is from about 0.01 to about 0.1 and b is from about 0.01 to about 0.2. In certain embodiments, a is 0.05 and b is 0.15. In certain embodiments, a is 0.03 and b is 0.17. In certain embodiments, the second electroactive material is LiAlNiCoO₂. In certain embodiments, the second electroactive material is LiAl_{0.05}Ni_{0.8}Co_{0.15}O₂.

### Electroactive Subparticles

a. Electroactive Material and Electroactive Subparticle for an Anode

In one embodiment, the electroactive subparticles used herein comprise an electroactive material. In certain embodiments, the electroactive material is an electroactive metal or metal oxide. Suitable electroactive metals and metal oxides include, but are not limited to, silicon, silicon monoxide (SiO), Si₂N₂O, Ge₂N₂O, boron oxide, titanium oxides (including titanium monoxide, titanium(III) oxide, and titanium dioxide), tin, tin oxides (including tin(II) oxide and tin dioxide), antimony, magnesium, zinc, zirconium oxide, cadmium, indium, aluminum, bismuth, germanium, lead, vanadium oxide, cobalt oxide, and combinations thereof. In certain embodiments, the electroactive material is an electroactive alloy. Suitable electrochemically active alloys include, but are not limited to, silicon alloys containing tin, a transition metal, and optionally carbon; silicon alloys containing a transition metal and aluminum; silicon alloys containing copper and silver; and alloys containing tin, silicon, or aluminum, yttrium, and a lanthanide or an actinide or a combination thereof.

In certain embodiments, the electroactive subparticles used herein comprise silicon, in one embodiment, silicon powder. In certain embodiments, the electroactive subparticles consist essentially of silicon, in one embodiment, silicon powder. In certain embodiments, the silicon is crystalline. In certain embodiments, the silicon is amorphous. In certain embodiments, the silicon is doped with boron, aluminum, gallium, antimony, phosphorus, or a combination thereof. In certain embodiments, the electroactive subparticles used herein comprise i) silicon, in one embodiment, silicon powder, and ii) carbon.

In certain embodiments, the electroactive subparticles used herein are isotropic. In certain embodiments, the electroactive subparticles used herein are homogeneous. In certain embodiments, the electroactive subparticles used herein are isotropic and homogenous.

In certain embodiments, the electroactive subparticles used herein have an average particle size ranging from about 10 nm to about 100 μm, from about 10 nm to about 10 μm, from about 20 nm to about 5 μm, from about 20 nm to about 1 μm, from about 20 to about 500, from about 50 to about 500 nm, from about 50 to about 400 nm, from about 50 to about 200 nm, or from about 100 to about 200 nm. In certain embodiments, the electroactive subparticles used herein have an average particle size of about 50 nm, about 100 nm, about 150 nm, about 200 nm, about 300 nm, about 400 nm, about 500 nm, about 1 μm, about 2 μm, about 5 μm, or about 10 μm.

In certain embodiments, the electroactive subparticles used herein have various shapes, including, but not limited to, sphere, spheroid, fibril, or platelet. In certain embodiments, the electroactive subparticles used herein are substantially spherical. In certain embodiments, the electroactive subparticles used herein are spherical. In certain embodiments, the electroactive subparticles used herein are spheroidal.

In certain embodiments, the electroactive subparticles used herein are coated to provide additional desired chemical and/or physical properties, such as chemical inertness (by coating with metal oxides, such as TiO₂, MoO₃, WO₃, Al₂O₃, or ZnO) or electrical conductivity (by coating with, e.g., ionic conductors or carbon). In certain embodiments, the electroactive subparticles used herein are coated with a metal oxide by mixing the electroactive subparticles with the metal oxide, e.g., in a grinder. In certain embodiments, the electroactive subparticles used herein are coated with a metal oxide by mixing the electroactive subparticles with a solution of polytitanic acid, polytungstic acid, polymolybdic acid, polytitanic acid peroxide, polytungstic acid peroxide, or polymolybdic acid peroxide, which forms the corresponding metal oxide upon dehydration.

In certain embodiments, the electroactive subparticles used herein are coated with a carbonized carbon layer. In certain embodiments, the electroactive subparticles used herein are first treated with a binder, including, but not limited to, asphalt pitch, pitch coke, petroleum coke, a sugar, coal tar, fluoranthene, pyrene, chrysene, phenanthrene, anthracene, naphthalin, fluorine, biphenyl, acenephthene, or a mixture thereof; and subsequently carbonized, in one embodiment, in an inert gas atmosphere, to form carbonized carbon layer on the surface of the electroactive subparticles.

In certain embodiments, the electroactive subparticles used herein are coated with carbon by thermal vapor deposition (CVD), as described in U.S. Pat. App. Pub. No. 2003/025711, the disclosure of which is incorporated herein by reference in its entirety.

b. Electroactive Material and Electroactive Subparticle for a Cathode

In one embodiment, the electroactive particle is an electroactive material. In certain embodiments, the electroactive material is a lithium compound. In one embodiment, the electroactive material is a lithium phosphate compound. In another embodiment, the electroactive material is LiMPO₄, wherein M is a transition metal. In yet another embodiment, M is a transition metal selected from the group consisting of Ti, V, Cr, Mn, Fe, Co, and Ni. In yet another embodiment, the electroactive material is LiFePO₄. In yet another embodiment, the electroactive material is LiMnPO₄. In yet another embodiment, the electroactive material is LiVPO₄. In yet another embodiment, the electroactive material is AM^{a}_{1-d}M^{b}_{d}PO₄, wherein A is Li, Na, or a mixture thereof; M^{a} is Fe, Co, Mn, or a mixture thereof; M^{b} is Mg, Ca, Zn, Ni, Co, Cu, Al, B, Cr, Nb, or a mixture thereof; and d is ranging from about 0.01 to about 0.99, from about 0.01 to about 0.5, from about 0.01 to about 0.30, or from about 0.01 to about 0.15. In yet another embodiment, the electroactive material is LiM^{a}_{1-d}M^{b}_{d}PO₄, wherein M^{a}, M^{b}, and d are each as defined herein. In still another embodiment, the electroactive material is NaM^{a}_{1-d}M^{b}_{d}PO₄, wherein M^{a}, M^{b}, and d are each as defined herein.

In certain embodiments, the electroactive material is a metal oxide. In one embodiment, the electroactive material is selected from the group consisting of LiCoO₂, LiNiCoO₂, LiNi_{c}Co_{1-c}O₂, wherein c is from about 0.05 to about 0.95, from about 0.1 to about 0.90, from about 0.2 to about 0.5, or from about 0.2 to about 0.4, Li(NiMnCo)_{1/3}O₂, Li(NiMn)_{1/2}O₂, LiV₂O₅, and mixtures thereof. In yet another embodiment, the electroactive material is LiCoO₂. In yet another embodiment, the electroactive material is LiNiCoO₂.

In yet another embodiment, the electroactive material is LiNi_{c}Co_{1-c}O₂, wherein c is ranging from about 0.05 to about 0.95, from about 0.1 to about 0.90, from about 0.2 to about 0.5, or from about 0.2 to about 0.4. In yet another embodiment, the electroactive material is LiNi_{c}Co_{1-c}O₂, wherein c is from about 0.2 to about 0.5, from about 0.2 to about 0.4, or about 0.3. In yet another embodiment, the electroactive material is Li(NiMnCo)_{1/3}O₂. In yet another embodiment, the electroactive material is Li(NiMn)_{1/2}O₂. In yet another embodiment, the electroactive material is LiV₂O₅.

In yet another embodiment, the electroactive material is LiNiₑMn_{f}Co_{1-e-f}O₂, wherein e and f are each independently ranging from 0 to about 0.95, from about 0.01 to about 0.9, from about 0.05 to about 0.80, from about 0.1 to about 0.5, or from about 0.2 to about 0.4, and the sum of e and f is less than 1. In yet another embodiment, the electroactive material is LiNiₑMn_{f}Co_{1-e-f}O₂, wherein e and f are 0.33.

In still another embodiment, the electroactive material is LiNi_{1-a-b}AlₐCo_{b}O₂, wherein a is from about 0.01 to about 0.9, from about 0.01 to about 0.7, from about 0.01 to about 0.5, from about 0.01 to about 0.4, from about 0.01 to about 0.3, from about 0.01 to about 0.2, or from about 0.01 to about 0.1; and b is from about 0.01 to about 0.9, from about 0.01 to about 0.7, from about 0.01 to about 0.5, from about 0.01 to about 0.4, from about 0.01 to about 0.3, from about 0.01 to about 0.2, or from about 0.01 to about 0.1; with the proviso that the sum of a and b is less than 1. In certain embodiments, a is from about 0.01 to about 0.5. In certain embodiments, a is from about 0.01 to about 0.1. In certain embodiments, b is from about 0.01 to about 0.9. In certain embodiments, b is from about 0.01 to about 0.2. In certain embodiments, a is from about 0.01 to about 0.1 and b is from about 0.01 to about 0.2. In certain embodiments, the electroactive material is LiAlNiCoO₂. In certain embodiments, the electroactive material is LiAl_{0.05}Ni_{0.8}Co_{0.15}O₂.

Each type of the electroactive subparticles in the electroactive agglomerated particles independently can have various shapes, including, but not limited to, sphere, spheroid, fibril, fiber, or platelet.

In certain embodiments, each type of the electroactive subparticles in the electroactive agglomerated particles independently has an average particle size ranging from about 1 to about 500 nm, from about 1 to about 200 nm, or from about 2 to about 100 nm.

In certain embodiments, the electroactive subparticles used herein are coated to provide additional desired chemical and/or physical properties, such as chemical inertness (by coating with metal oxides, such as TiO₂, MoO₃, WO₃, Al₂O₃, or ZnO) or electrical conductivity (by coating with, e.g., ionic conductors or carbon). In certain embodiments, the electroactive subparticles used herein are coated with a metal oxide by mixing the electroactive subparticles with the metal oxide, e.g., in a grinder. In certain embodiments, the electroactive subparticles used herein are coated with a metal oxide by mixing the electroactive subparticles with a solution of polytitanic acid, polytungstic acid, polymolybdic acid, polytitanic acid peroxide, polytungstic acid peroxide, or polymolybdic acid peroxide, which forms the corresponding metal oxide upon dehydration.

In certain embodiments, the electroactive subparticles used herein are coated with a carbonized carbon layer. In certain embodiments, the electroactive subparticles used herein are first treated with a binder, including, but not limited to, asphalt pitch, pitch coke, petroleum coke, a sugar, coal tar, fluoranthene, pyrene, chrysene, phenanthrene, anthracene, naphthalin, fluorine, biphenyl, acenephthene, or a mixture thereof; and subsequently carbonized, in one embodiment, in an inert gas atmosphere, to form carbonized carbon layer on the surface of the electroactive subparticles.

In certain embodiments, the electroactive subparticles used herein are coated with carbon by thermal vapor deposition (CVD), as described in U.S. Pat. App. Pub. No. 2003/025711, the disclosure of which is incorporated herein by reference in its entirety.

### Polymeric Overcoating

In one embodiment, the polymeric overcoating is an organic polymer. Suitable polymeric overcoatings include, but are not limited to, polyamideimides, polyimides, polytetrafluoroethylene (PTFE), carboxymethyl cellulose (CMC), polyvinylidene fluoride (PVDF), polyvinyl alcohol (PVA), styrene butadiene rubber (SBR), and mixtures thereof. In certain embodiments, the polymeric overcoating is a polyamideimide. In certain embodiments, the polymeric overcoating is a polyimide. In certain embodiments, the polymeric overcoating is a carboxymethyl cellulose.

In certain embodiments, the polymeric overcoating material is a crosslinkable polymer. Suitable crosslinkable polymers include, but are not limited to, polybenzophenones, polyacrylates, polyvinyls, polystyrenes, polysulfones, 2,3-dihydrofuran-containing polymers, carboxymethyl celluloses (CMC), polyamideimides, polyimides, styrene-containing copolymers, and mixtures thereof. In certain embodiments, the crosslinkable polymer is a polyamideimide. In certain embodiments, the crosslinkable polymer is a polyimide. In certain embodiments, the crosslinkable polymer is a carboxymethyl cellulose.

In certain embodiments, the polymeric overcoating material is a crosslinked polymer. Suitable crosslinked polymers include, but are not limited to, polybenzophenones, polyacrylates, polyvinyls, polystyrenes, polysulfones, 2,3-dihydrofuran-containing polymers, carboxymethyl celluloses (CMC), polyamideimides, polyimides, styrene-containing copolymers, and mixtures thereof. In certain embodiments, the crosslinked polymer is a polyamideimide. In certain embodiments, the crosslinked polymer is a polyimide. In certain embodiments, the crosslinked polymer is a carboxymethyl cellulose.

In certain embodiments, the polymeric overcoating is a thermally crosslinkable polymer. Suitable thermally crosslinkable polymers include, but are not limited to, polybenzophenones, polyacrylates, polyvinyls, polystyrenes, polysulfones, 2,3-dihydrofuran-containing polymers, carboxymethyl celluloses (CMC), polyamideimides, polyimides, styrene-containing copolymers, and mixtures thereof. In certain embodiments, the thermally crosslinkable polymer is a polyamideimide. In certain embodiments, the thermally crosslinkable polymer is a polyimide. In certain embodiments, the thermally crosslinkable polymer is a carboxymethyl cellulose.

In certain embodiments, the polymeric overcoating is a thermally crosslinked polymer. Suitable thermally crosslinked polymers include, but are not limited to, polybenzophenones, polyacrylates, polyvinyls, polystyrenes, polysulfones, 2,3-dihydrofuran-containing polymers, carboxymethyl celluloses (CMC), polyamideimides, polyimides, styrene-containing copolymers, and mixtures thereof. In certain embodiments, the thermally crosslinked polymer is a polyamideimide. In certain embodiments, the thermally crosslinked polymer is a polyimide. In certain embodiments, the thermally crosslinked polymer is a carboxymethyl cellulose.

In certain embodiments, the polymeric overcoating is a photo crosslinkable polymer. Suitable photo crosslinkable polymers include, but are not limited to, polybenzophenones, polyacrylates, polyvinyls, polystyrenes, polysulfones, 2,3-dihydrofuran-containing polymers, styrene-containing copolymers, and mixtures thereof.

In certain embodiments, the polymeric overcoating is a photo crosslinked polymer. Suitable photo crosslinked polymers include, but are not limited to, polybenzophenones, polyacrylates, polyvinyls, polystyrenes, polysulfones, 2,3-dihydrofuran-containing polymers, styrene-containing copolymers, and mixtures thereof.

In certain embodiments, the polymeric overcoating is formed from its precursors via polymerization on the surface of the core of the coated electroactive particle provided herein. In certain embodiments, the precursors of a polymer are monomers of the polymer. In certain embodiments, the precursors of a polymer are crosslinkable polymers. In certain embodiments, the polyamideimide as a polymeric overcoating is formed from a polyamideimide via crosslinking on the surface of the core of the coated electroactive particle provided herein. In certain embodiments, the polyimide as a polymeric overcoating is formed from a polyimide via crosslinking on the surface of the core of the coated electroactive particle provided herein.

In one embodiment, the polymeric overcoating is a polyamideimide, polyimide, or a mixture thereof. In certain embodiments, the polyamideimide is aromatic, aliphatic, cycloaliphatic, or a mixture thereof. In certain embodiments, the polyamideimide is an aromatic polyamideimide. In certain embodiments, the polyamideimide is an aliphatic polyamideimide. In certain embodiments, the polyamideimide is a cycloaliphatic polyamideimide. In certain embodiments, the polyimide is aromatic, aliphatic, cycloaliphatic, or a mixture thereof. In certain embodiments, the polyimide is an aromatic polyimide. In certain embodiments, the polyimide is an aliphatic polyimide. In certain embodiments, the polyimide is a cycloaliphatic polyimide.

In certain embodiments, the polymeric overcoating is TORLON® AI-30, TORLON® AI-50, TORLON® 4000, or TORLON® 4203L (Solvay Advanced Polymers, L.L.C., Ao0yaretta, GA); or formed from U-VARNISH® (UBE American Inc., New York, N.Y.). In certain embodiments, the polymeric overcoating is TORLON® AI-30. In certain embodiments, the polymeric overcoating is TORLON® AI-50. In certain embodiments, the polymeric overcoating is TORLON® 4000. In certain embodiments, the polymeric overcoating is TORLON® 4203L. In certain embodiments, the polymeric overcoating is a polyimide formed from U-VARNISH® (UBE American Inc., New York, N.Y.).

Some other suitable polyamideimide and polyimides include those described in Loncrini and Witzel, Journal of Polymer Science Part A-1: Polymer Chemistry 1969, 7, 2185-2193; Jeon and Tak, Journal of Applied Polymer Science 1996, 60, 1921-1926; Seino et al., Journal of Polymer Science Part A: Polymer Chemistry 1999, 37, 3584-3590; Seino et al., High Performance Polymers 1999, 11, 255-262; Matsumoto, High Performance Polymers 2001, 13, S85-S92; Schab-Balcerzak et al., European Polymer Journal 2002, 38, 423-430; Eichstadt et al., Journal of Polymer Science Part B: Polymer Physics 2002, 40, 1503-1512; and Fang et al., Polymer 2004, 45, 2539-2549; the disclosure of each of which is incorporated herein by reference in its entirety.

In certain embodiments, the polyamideimide as a polymeric overcoating is formed from a polyanhydride and a polyamine via polymerization on the surface of the core of the coated electroactive particle provided herein.

In certain embodiments, the polyimide as a polymeric overcoating is formed from a polyanhydride and a polyamine via polymerization on the surface of the core of the coated electroactive particle provided herein.

In certain embodiments, the aromatic, aliphatic, or cycloaliphatic polyamideimide overcoating is formed via a condensation reaction of an aromatic, aliphatic, or cycloaliphatic polyanhydride, in one embodiment, a dianhydride, with an aromatic, aliphatic, or cycloaliphatic polyamine, in one embodiment, a diamine or triamine.

In certain embodiments, the aromatic, aliphatic, or cycloaliphatic polyimide overcoating is formed via a condensation reaction of an aromatic, aliphatic, or cycloaliphatic polyanhydride, in one embodiment, a dianhydride, with an aromatic, aliphatic, or cycloaliphatic polyamine, in one embodiment, a diamine or triamine, to form a polyamic acid; followed by chemical or thermal cyclization to form the polyimide.

Suitable polyanhydrides, polyamines, polyamideimide, and polyimides include those described in Eur. Pat. App. Pub. Nos. EP 0450549 and EP 1246280; U.S. Pat. No. 5,504,128; and U.S. Pat. App. Pub. Nos. 2006/0099506 and 2007/0269718, the disclosure of each of which is incorporated herein by reference in its entirety.

Suitable polyanhydrides include, but are not limited to, butanetetracarboxylic dianhydride, meso-1,2,3,4-butanetetracarboxylic dianhydride, dl-1,2,3,4-butanetetracarboxylic dianhydride, cyclobutane tetracarboxylic dianhydride, 1,2,3,4-cyclopentane tetracarboxylic dianhydride, cyclohexane tetracarboxylic dianhydride, 1,2,3,4-cyclohexanetetracarboxylic dianhydride, cis-1,2,3,4-cyclohexanetetracarboxylic dianhydride, trans-1,2,3,4-cyclohexanetetracarboxylic dianhydride, bicyclo[2.2.2]octane-2,3,5,6-tetracarboxylic 2,3:5,6-dianhydride, bicyclo[2.2.2]oct-7-ene-2,3,5,6-tetracarboxylic dianhydride, bicyclo[2.2.1]-heptane-2,3,5,6-tetracarboxylic 2,3:5,6-dianhydride, (4arH, 8acH)-decahydro-1,t,4t:5c,4-cyclohexene-1,1,2,2-tetracarboxylic 1,2:1,2-dianhydride, bicyclo[2.2.1]heptane-2-exo-3-exo-5-exo-tricarboxyl-5-endo-acetic dianhydride, bicyclo[4.2.0]oxetane-1,6,7,8-tetracarboxylic acid intramolecular dianhydride, 3,3′,4,4′-diphenylsulfonetetracarboxylic dianhydride, 4,4′-hexafluoropropylidene bisphthalic dianhydride, 1,3-bis(3,4-dicarboxyphenyl)-1,1,3,3-tetramethyldisiloxane, and combinations thereof.

Suitable polyamines include, but are not limited to, 4,4′-methylenebis(2,6-dimethylaniline), 4,4′-oxydianiline, m-phenylenediamine, p-phenylenediamine, benzidene, 3,5-diaminobenzoic acid, o-dianisidine, 4,4′-diaminodiphenyl methane, 4,4′-methylenebis(2,6-dimethylaniline), 1,4-diaminobutane, 1,6-diaminohexane, 1,7-diaminoheptane, 1,9-diaminononane, 1,10-diaminodecane, 1,12-diaminododecane, 5-amino-1,3,3-trimethylcyclohexanemethylamine, 2,5-bis(aminomethyl)bicyclo[2.2.1]heptane, 2,6-bis(aminomethyl)bicyclo[2.2.1]heptane, 2,4-diaminotoluene, 1,4-diamino-2-methoxybenzene, 1,4-diamino-2-phenylbenzene and 1,3-diamino-4-chlorobenzene, 4,4′-diaminobiphenyl, 2,2-bis(4-aminophenyl)propane, 2,2-bis[4-(4-aminophenoxy)phenyl]propane, 2,2-bis(4-aminophenyl)-1,1,1,3,3,3-hexafluoropropane, 2,2-bis(4-aminophenoxyphenyl)hexafluoropropane, 4,4′-diaminodiphenyl ether, 3,4-diaminodiphenyl ether, 1,3-bis(3-aminophenoxy)benzene, 1,3-bis(4-aminophenoxy)benzene, 1,4-bis(4-aminophenoxy)benzene, 4,4′-bis(4-aminophenoxy)biphenyl, 4,4′-bis(3-aminophenoxy)biphenyl, 2,2-bis[4-(4-aminophenoxy)phenyl]propane, 2,2-bis[4-(4-aminophenoxy)phenyl]propane, 2,2-bis[4-(4-aminophenoxy)phenyl]-1,1,1,3,3,3-hexafluoropropane, 4,4′-diaminodiphenyl thioether, 4,4′-diaminodiphenyl sulfone, 2,2′-diaminobenzophenone, 3,3′-diaminobenzophenone, naphthalene diamines (including 1,8-diaminonaphthalene and 1,5-diaminonaphthalene), 2,6-diaminopyridine, 2,4-diaminopyrimidine, 2,4-diamino-s-triazine, 1,8-diamino-4-(aminomethyl)octane, bis[4-(4-aminophenoxy)-phenyl]sulfone, 3,3′-dihydroxy-4,4′-diaminobiphenyl, 2,2-bis(3-amino-4-hydroxyphenyl)hexafluoropropane, 2,2-bis(3-hydroxy-4-aminophenyl)propane, and combinations thereof.

In certain embodiments, the polyimide is poly(4,4′-phenyleneoxyphenylene pyromellitic imide) or poly(4,4′-phenyleneoxyphenylene-co-1,3-phenylene-benzophenonetetracarboxylic diimide).

In certain embodiments, a conductive polymer is also added to the polymeric overcoating to increase the conductivity of the coated electroactive particle. Suitable conductive polymers include, but are not limited to, polythiophene, poly(3-hexylthiophene), poly(2-acetylthiophene), polybenzothiopnene, poly(2,5-dimethylthiophene), poly(2-ethylthiophene), poly(3-carboxylic ethyl thiophene), polythiopheneacetonitrile, poly(3,4-ethylenedioxythiophene), polyisothianaphthene, polypyrrole, polyaniline, and polyparaphenylene. In certain embodiments, the conductive polymer is added to the overcoating polymer or precursors in an amount ranging from about 1 to about 40%, from about 2 to about 20%, from about 3 to about 15%, or from about 5 to about 10% of the total weight of the polymeric overcoating polymer and the conductive polymer. In certain embodiments, the conductive polymer is added to the overcoating polymer or precursors first before contacting with the electroactive agglomerated particles or the subparticles.

### Methods of Preparation

In one embodiment, provided herein is a method for preparing the coated electroactive particles provided herein, which comprises the steps of: i) covering the surfaces of electroactive subparticles with a layer of a polymer in a solvent; and ii) curing the electroactive subparticles at an elevated temperature to form the coated electroactive particles. In certain embodiments, the polymer is a crosslinkable polymer. In certain embodiments, the polymer is a polyamideimide. In certain embodiments, the polymer is a polyimide.

In another embodiment, provided herein is a method for preparing the coated electroactive particles provided herein, which comprises the steps of: i) covering the surfaces of electroactive subparticles with a layer of a mixture of precursors of a polymer in a solvent; and ii) curing the electroactive subparticles at an elevated temperature to form the coated electroactive particles. In certain embodiments, the polymer is a crosslinked polymer. In certain embodiments, the polymer is a crosslinkable polymer. In certain embodiments, the precursors are crosslinkable polymers. In certain embodiments, the precursors are monomers. In certain embodiments, the polymer is a polyamideimide. In certain embodiments, the polymer is a polyimide. In certain embodiments, the precursors are crosslinkable polyamideimides. In certain embodiments, the precursors are crosslinkable polyimides. In certain embodiments, the precursors are a polyanhydride and polyamine.

In yet another embodiment, provided herein is a method for preparing the coated electroactive particles provided herein, which comprises the steps of: i) mixing electroactive subparticles with a binder in a solvent to form electroactive agglomerated particles; ii) covering the surface of the electroactive agglomerated particles with a layer of a polymer in a solvent; and iii) curing the electroactive agglomerated particles at an elevated temperature to form the coated electroactive particles. In certain embodiments, the polymer is a crosslinkable polymer. In certain embodiments, the polymer is a polyamideimide. In certain embodiments, the polymer is a polyimide.

In yet another embodiment, provided herein is a method for preparing the coated electroactive particles provided herein, which comprises the steps of: i) mixing electroactive subparticles with a binder to form electroactive agglomerated particles; ii) covering the surface of the electroactive agglomerated particles with a layer of a mixture of precursors of a polymer in a solvent; and iii) curing the electroactive agglomerated particles at an elevated temperature to form the coated electroactive particles. In certain embodiments, the polymer is a crosslinked polymer. In certain embodiments, the polymer is a crosslinkable polymer. In certain embodiments, the precursors are crosslinkable polymers. In certain embodiments, the precursors are monomers. In certain embodiments, the polymer is a polyamideimide. In certain embodiments, the polymer is a polyimide. In certain embodiments, the precursors are crosslinkable polyamideimides. In certain embodiments, the precursors are crosslinkable polyimides. In certain embodiments, the precursors are a polyanhydride and polyamine.

In yet another embodiment, provided herein is a method for preparing the coated electroactive particles provided herein, which comprises the steps of: i) mixing electroactive subparticles with a polymer in a solvent to form a slurry; ii) air-injecting the slurry to form particles; and iii) curing the particles from step ii) at an elevated temperature to form the coated electroactive particles. In certain embodiments, the polymer is a crosslinkable polymer. In certain embodiments, the polymer is a polyamideimide. In certain embodiments, the polymer is a polyimide.

In yet another embodiment, provided herein is a method for preparing the coated electroactive particles provided herein, which comprises the steps of: i) mixing electroactive subparticles with a mixture of precursors of a polymer in a solvent to form a slurry; ii) air-injecting the slurry to form particles; and iii) curing the particles from step ii at an elevated temperature to form the coated electroactive particles. In certain embodiments, the polymer is a crosslinked polymer. In certain embodiments, the polymer is a crosslinkable polymer. In certain embodiments, the precursors are crosslinkable polymers. In certain embodiments, the precursors are monomers. In certain embodiments, the polymer is a polyamideimide. In certain embodiments, the polymer is a polyimide. In certain embodiments, the precursors are crosslinkable polyamideimides. In certain embodiments, the precursors are crosslinkable polyimides. In certain embodiments, the precursors are a polyanhydride and polyamine.

In yet another embodiment, provided herein is a method for preparing the coated electroactive particles provided herein, which comprises the steps of: i) mixing subparticles of a first electroactive material and subparticles of a second electroactive material with a polymer in a solvent to form a slurry; ii) air-injecting the slurry to form agglomerated particles; and iii) curing the agglomerated particles from step ii) at an elevated temperature to form the coated electroactive particles. In certain embodiments, the polymer is a crosslinkable polymer. In certain embodiments, the polymer is a polyamideimide. In certain embodiments, the polymer is a polyimide.

In still another embodiment, provided herein is a method for preparing the coated electroactive particles provided herein, which comprises the steps of: i) mixing subparticles of a first electroactive material and subparticles of a second electroactive material with a mixture of precursors of a polymer in a solvent to form a slurry; ii) air-injecting the slurry to form particles; and iii) curing the particles from step ii at an elevated temperature to form the coated electroactive particles. In certain embodiments, the polymer is a crosslinked polymer. In certain embodiments, the polymer is a crosslinkable polymer. In certain embodiments, the precursors are crosslinkable polymers. In certain embodiments, the precursors are monomers. In certain embodiments, the polymer is a polyamideimide. In certain embodiments, the polymer is a polyimide. In certain embodiments, the precursors are crosslinkable polyamideimides. In certain embodiments, the precursors are crosslinkable polyimides. In certain embodiments, the precursors are a polyanhydride and polyamine.

The certain embodiments, the methods provided herein further comprise the step of grinding the coated electroactive particles into predetermined particle sizes.

The mixing step can be performed using any conventional method known to one of ordinary skill in the art, including, but not limited to, ball mixing, cospraying, such as thermal spraying and ultrasonic spraying. The production method will depend on the nature of the subparticles or the agglomerated particles employed.

In certain embodiments, the elevated temperature is ranging from about 100 to about 1,000° C., from about 150 to about 750° C., from about 200 to about 700° C., from about 300 to about 600° C., or from about 300 to about 500° C. In certain embodiments, the elevated temperature is about 200° C., about 250° C., about 300° C., about 350° C., about 400° C., about 450° C., about 500° C., about 550° C., or about 600° C.

In certain embodiments, the solvent is N-methylpyrrolidinone (NMP).

### Electrode Comprising the Coated Electroactive Particles

In one embodiment, provided herein is an electrode that comprises the coated electroactive particles provided herein, a current collector, and optionally a binder.

In another embodiment, provided herein is an electrode that comprises i) a coated electroactive particle that comprises (a) a core comprising one or more electroactive materials, and optionally a binder; and (b) a polymeric overcoating on the surface of the core; ii) a current collector; and iii) optionally a binder.

In another embodiment, provided herein is an electrode that comprises i) a coated electroactive particle comprising (a) a core that comprises an electroactive subparticle; an agglomerated particle comprising at least two electroactive subparticles and optionally a binder; or an agglomerated particle comprising at least one electroactive subparticle, at least one diluent subparticle, and optionally a binder; and (b) a polymeric overcoating on the surface of the core; ii) a current collector; and iii) optionally a binder.

In yet another embodiment, provided herein is an electrode that comprises i) a coated electroactive particle comprising at least one electroactive subparticle and an organic polymer, wherein the outside surface of the electroactive subparticle is substantially coated with the organic polymer; ii) a current collector; and iii) optionally a binder.

The electrode comprising the coated electroactive particles can be used, for example, as either anodes or cathodes in batteries, depending on the electroactive subparticles used in forming the coated electroactive particles. In certain embodiments, the electrode comprising the coated electroactive particles are used as an anode. In certain embodiments, the electrode comprising the coated electroactive particles are used as an anode for a lithium ion battery. In certain embodiments, the electrode comprising the coated electroactive particles are used as a cathode. In certain embodiments, the electrode comprising the coated electroactive particles are used as a cathode for a lithium ion battery.

Examples of suitable materials for the current collector include, but are not limited to, carbon, copper, nickel, silver, and combinations thereof. Some suitable binders include those as described herein. In certain embodiments, the binder is selected from the group consisting of polyvinylidene fluoride (PVDF), carboxymethyl cellulose (CMC), styrene butadiene rubber (SBR), polyamideimides, polyimides, ethylene propylene diene monomer (EPDM), polyethylene oxides (PEO or PEG), polyethersulfones, polyphenylsulfones, and mixtures thereof.

In certain embodiments, the electrode is prepared by pressing the coated electroactive particles provided herein onto a current collector (e.g., a foil, strip, or sheet) to form an electrode. In certain embodiments, the electrode is prepared by dispersing the coated electroactive particles provided herein into a solvent, in one embodiment, N-methylpyrrolidinone (NMP), to form a slurry; and coating the slurry onto a current collect.

a. Anodes

In one embodiment, provided herein is an electrode that comprises i) a coated electroactive particle that comprises (a) a core comprising one or more electroactive materials for an anode, and optionally a binder; and (b) a polymeric overcoating on the surface of the core; ii) a current collector; and iii) optionally a binder.

In another embodiment, provided herein is an electrode that comprises i) a coated electroactive particle comprising (a) a core that comprises an electroactive subparticle for an anode; an agglomerated particle comprising at least two electroactive subparticles for an anode and optionally a binder; or an agglomerated particle comprising at least one electroactive subparticle for an anode, at least one diluent subparticle, and optionally a binder; and (b) a polymeric overcoating on the surface of the core; ii) a current collector; and iii) optionally a binder.

In yet another embodiment, provided herein is an electrode that comprises i) a coated electroactive particle comprising at least one electroactive subparticle for an anode and an organic polymer, wherein the outside surface of the electroactive subparticle is substantially coated with the organic polymer; ii) a current collector; and iii) optionally a binder.

In yet another embodiment, provided herein is an anode that comprises the coated electroactive particles that comprise subparticles of an electroactive material for an anode, a current collector, and optionally a binder. In certain embodiments, the electroactive material is silicon, a silicon alloy, a silicon oxide, or a mixture thereof.

In certain embodiments, the current collector is copper. In certain embodiments, the current collector is copper foil. In certain embodiments, the current collector is rolled copper foil. In certain embodiments, the current collector is electrodeposited copper foil. In certain embodiments, the copper has a horizontal tensile strength ranging from about 100 to about 500 N/mm², from about 200 to about 450 N/mm², from about 250 to about 450 N/mm², or from about 300 to about 400 N/mm². In certain embodiments, the copper has a horizontal tensile strength of about 200, about 220, about 240, about 260, about 270, about 280, about 290, about 300, about 310, about 320, about 330, about 340, about 360, about 380, about 400, about 420, about 440, about 460, about 480, or about 500 N/mm². In certain embodiments, the copper has a vertical tensile strength ranging from about 100 to about 500 N/mm², from about 200 to about 450 N/mm², from about 250 to about 450 N/mm², or from about 300 to about 400 N/mm². In certain embodiments, the copper has a vertical horizontal strength of about 200, about 220, about 240, about 260, about 270, about 280, about 290, about 300, about 310, about 320, about 330, about 340, about 360, about 380, about 400, about 420, about 440, about 460, about 480, or about 500 N/mm².

Some suitable binders include those as described herein. In certain embodiments, the binder is selected from the group consisting of polyvinylidene fluoride (PVDF), carboxymethyl cellulose (CMC), styrene butadiene rubber (SBR), polyamideimides, polyimides, ethylene propylene diene monomer (EPDM), polyethylene oxides (PEO or PEG), polyethersulfones, polyphenylsulfones, and mixtures thereof.

b. Cathodes

In one embodiment, provided herein is an electrode that comprises i) a coated electroactive particle that comprises (a) a core comprising one or more electroactive materials for a cathode, and optionally a binder; and (b) a polymeric overcoating on the surface of the core; ii) a current collector; and iii) optionally a binder.

In another embodiment, provided herein is an electrode that comprises i) a coated electroactive particle comprising (a) a core that comprises an electroactive subparticle for a cathode; an agglomerated particle comprising at least two electroactive subparticles for a cathode and optionally a binder; or an agglomerated particle comprising at least one electroactive subparticle for a cathod, at least one diluent subparticle, and optionally a binder; and (b) a polymeric overcoating on the surface of the core; ii) a current collector; and iii) optionally a binder.

In yet another embodiment, provided herein is an electrode that comprises i) a coated electroactive particle comprising at least one electroactive subparticle for a cathode and an organic polymer, wherein the outside surface of the electroactive subparticle is substantially coated with the organic polymer; ii) a current collector; and iii) optionally a binder.

In one embodiment, provided herein is a cathode that comprises the electroactive agglomerated particles or coated electroactive particles, which comprise an electroactive material for a cathode, a current collector, and optionally a binder.

Examples of suitable materials for the current collector include, but are not limited to, aluminum, nickel, silver, and combinations thereof. Some suitable binders include those as described herein. In certain embodiments, the binder is selected from the group consisting of polyvinylidene fluoride (PVDF), carboxymethyl cellulose (CMC), styrene butadiene rubber (SBR), polyamideimides, polyimides, ethylene propylene diene monomer (EPDM), polyethylene oxides (PEO or PEG), polyethersulfones, polyphenylsulfones, and mixtures thereof.

In certain embodiments, the cathode is prepared by pressing the electroactive agglomerated particles or coated electroactive particles provided herein onto a current collector (e.g., a foil, strip, or sheet) to form a cathode. In certain embodiments, the cathode is prepared by dispersing the electroactive agglomerated particles or coated electroactive particles provided herein into a solvent, in one embodiment, N-methylpyrrolidinone (NMP), to form a slurry; and coating the slurry onto a current collect.

### Lithium Secondary Battery

In certain embodiments, provided herein is a lithium secondary battery, which comprises an anode comprising the coated electroactive particles provided herein, a cathode; and electrolyte that separates the anode and cathode. The cathode can be any cathode for a lithium secondary battery known to one of ordinary skill in the art.

In one embodiment, provided herein is a lithium battery, which comprises i) an anode comprising a coated electroactive particle that comprises (a) a core comprising one or more electroactive materials, and optionally a binder; and (b) a polymeric overcoating on the surface of the core; ii) a cathode; and iii) electrolyte that separates the anode and cathode. In certain embodiments, the binder is a polymeric binder.

In another embodiment, provided herein is a lithium battery, which comprises i) an anode comprising a coated electroactive particle, which comprises (a) a core that comprises an electroactive subparticle; an agglomerated particle comprising at least two electroactive subparticles and optionally a binder; or an agglomerated particle comprising at least one electroactive subparticle, at least one diluent subparticle, and optionally a binder; ii) a cathode; and iii) electrolyte that separates the anode and cathode.

In yet another embodiment, provided herein is a lithium battery, which comprises i) an anode comprising a coated electroactive particle, which comprises at least one electroactive subparticle and an organic polymer, wherein the outside surface of the electroactive subparticle is substantially coated with the organic polymer; ii) a cathode; and iii) electrolyte that separates the anode and cathode.

In one embodiment, the cathode comprises coated electroactive particles provided herein, a current collector, and optionally a binder, wherein the coated electroactive particles are coated onto the surface of the current collector. In another embodiment, the cathode comprises a current collector, a lithium-containing electroactive material, and optionally a binder, wherein the lithium-containing electroactive material is coated onto the surface of the current collector. In yet another embodiment, the cathode comprises electroactive agglomerated particles that comprise at least two electroactive materials, wherein the electroactive agglomerated particles are coated onto the surface of the current collector. In still another embodiment, the cathode comprises electroactive agglomerated particles that comprise at least two types of electroactive nanoparticles provided herein, wherein the electroactive agglomerated particles are coated onto the surface of the current collector. Further examples of suitable electroactive agglomerated particles include those as described in U.S. Pat. App. Pub. No. 2008/0116423, the disclosure of which is incorporated herein by reference in its entirety.

In certain embodiments, provided herein is a lithium secondary battery, which comprises a cathode comprising the coated electroactive particles or agglomerated particles provided herein, an anode; and electrolyte that separates the anode and cathode.

The anode can be any anode for a lithium secondary battery known to one of ordinary skill in the art. In one embodiment, the anode comprises coated electroactive particles provided herein, a current collector, and optionally a binder, wherein the coated electroactive particles are coated onto the surface of the current collector. In another embodiment, the anode comprises a current collector and an electroactive material, a current collector, and optionally a binder, wherein the electroactive material is coated onto the surface of the current collector. In certain embodiments, the electroactive material of the anode is a carbonaceous material. In certain embodiments, the electroactive material is mesocarbon microbead. In certain embodiments, the carbonaceous material is graphite, coke, petroleum coke, carbon, a partially or fully graphitized carbon, carbon-black, hard carbon, or a mixture thereof.

Any electrolytes known to one of ordinary skill in the art can be used in the battery provided herein. In certain embodiments, the electrolyte comprises one or more lithium salts and a charge carrying medium in the form of a solid, liquid, or gel. Suitable lithium salts include, but are not limited to LiPF₆, LiBF₄, LiClO₄, lithium bis(oxalato)borate, LiN(CF₃SO₂)₂, LiN(C₂F₅SO₂)₂, LiAsF₆, LiC(CF₃SO₂)₃, and combinations thereof.

Suitable examples of solid charge carrying media include, but are not limited to, polymeric media, e.g., polyethylene oxide. Suitable examples of liquid charge carrying media include, but are not limited to, ethylene carbonate, propylene carbonate, dimethyl carbonate, diethyl carbonate, ethyl-methyl carbonate, butylene carbonate, vinylene carbonate, fluorinated ethylene carbonate, fluorinated propylene carbonate, γ-butylrolactone, methyl difluoroacetate, ethyl difluoroacetate, dimethoxyethane, diglyme (i.e., bis(2-methoxyethyl) ether), tetrahydrofuran, dioxolane, and combinations thereof. Some examples of charge carrying media gels include those described in U.S. Pat. Nos. 6,387,570 and 6,780,544, the disclosure of each of which is incorporated herein by reference in its entirety.

The disclosure will be further understood by the following non-limiting examples.

### EXAMPLES

### Example 1

### Electrode and Cell Fabrication

Negative and positive electrodes were coated onto an Al foil and Cu foil, respectively, using a small doctor blade coater, and then calendared to designed thickness. The electrodes were then slited to designed width and dried in a vacuum oven at an elevated temperature. Once the electrodes were dried, all subsequent cell fabrication steps were carried out inside a drying room at a Dew point of about −35° C. The electrodes were tabbed first and then wound into jellyrolls. The jellyrolls were then inserted into an 18650 can and an EC based electrolyte was put into the cell under vacuum. The cells were crimped for sealing after electrolyte filling. The cell was then be aged and formed.

### Example 2

### Cell Testing

The cell was tested one week after formation. The cell capacities and voltage profiles at ˜1 C and ˜5 C (or ˜10 C for the Mn mixed particle) were measured by the following procedure: i) the cell was charged to 3.9V at 0.6 A for 2.5 hours; ii) the cell then rested for several minutes; iii) the cell was discharged to 2.2 V at 1 C rate; iv) the cell rested for another several minutes; v) the cell was then charged to 3.9V at 0.6 A; vi) the cell rested for several minutes; and vii) the cell was discharged to 2.2 V at ˜5 C or ˜10 C depending on the mixed particles.

### Example 3

### Preparation of Electroactive Agglomerated Particles

Electroactive agglomerated particles comprising LiFePO₄ nanoparticles, metal oxide nanoparticles, coal tar, and carbon black were prepared by mixing LiFePO₄ and metal oxide nanoparticles together, contacting the subparticle mixture with a coal tar fume and carbon black, and ball mixing the nanoparticle mixture. The metal oxide particles used herein are LiMn₂O₄, Li(NiCoMn)_{1/3}O₂, or LiAl_{0.05}Ni_{0.8}Co_{0.15}O₂ nanoparticles. The electroactive agglomerated particles can be crushed into predetermined particle sizes (e.g., in the range of about 1 to about 50 μm).

### Example 4

### Preparation of Electroactive Agglomerated Particles

Fe₂O₃ is mixed with Li₂CO₃ and (NH₄)₂HPO₄ in the presence of carbon. To the mixture is then added nanoparticles of a second electroactive material. The mixture is then thoroughly mixed again. The resulting mixture is heated under N₂ at an elevated temperature from about 700 to about 850° C. to yield electroactive agglomerated particles comprising LiFePO₄ nanoparticles and the nanoparticles of a second electroactive material. The electroactive agglomerated particles can be crushed into predetermined particle sizes (e.g., in the range of about 1 to about 50 μm).

### Example 5

### Preparation of Electroactive Agglomerated Particles

Fe₂O₃ particles are mixed with LiH₂PO₄ and Mg(OH)₂ particles in the presence of carbon. To the mixture are added nanoparticles of a second electroactive material. The mixture is then thoroughly mixed. The resulting mixture is heated under N₂ at an elevated temperature from about 700 to about 850° C. to yield electroactive agglomerated particles comprising LiFe₁₋ₓMgₓPO₄ nanoparticles and the nanoparticles of a second electroactive material. The electroactive agglomerated particles can be crushed into predetermined particle sizes (e.g., in the range of about 1 to about 50 μm).

### Example 6

### Preparation of Electroactive Agglomerated Particles

LiFePO₄ is prepared via a sol-gel synthesis from Fe(NO₃)₃.9H₂O, lithium acetate dehydrate, and phosphoric acid (85%). The iron nitrate and lithium acetate are combined with phosphoric acid (85%) in a stoichiometric ratio of 1:1:1. Distilled water is then added until all the constituents are completely dissolved. Nanoparticles of a second electroactive material, such as a metal oxide, are added. The pH of the mixture is adjusted to 8.5 to 9.5 using NH₄OH to form a sol. The sol is then heated on a hot plate with stirring to form a gel. The sample is then fired to 500° C. The mixture is then ground using a planetary ball mill in a solvent, such as ethanol and acetone. The grinding solvent is then evaporated under nitrogen and the resulting powder is thoroughly mixed and fired to about 600° C. to yield embedded electroactive agglomerated particles which comprises LiFePO₄ nanoparticles and the nanoparticles of a second electroactive material. The electroactive agglomerated particles can be crushed into predetermined particle sizes (e.g., in the range of about 1 to about 50 μm).

### Example 7

### Preparation of Electroactive Agglomerated Particles

LiFePO₄, LiAl_{0.05}Ni_{0.8}Co_{0.15}O₂, and carbon nanoparticles were ball mixed with coke. The mixture was hot spray dried to form agglomerated particles, which were further heat treated at about 300° C. The agglomerated particles were then crushed to form electroactive agglomerated particles having a particle size in the range of 1 to 50 μm.

Two different types of electroactive agglomerated particles were prepared. Agglomerated Particle I comprises about 78% by weight of LiFePO₄, about 20% by weight of LiAl_{0.05}Ni_{0.8}Co_{0.15}O₂, and about 1.5% carbon. Agglomerated Particle II comprises about 68% by weight of LiFePO₄, about 30% by weight of LiAl_{0.05}Ni_{0.8}Co_{0.15}O₂, and about 1.2% carbon.

Their electrochemical properties were compared with those of Physical Mixture II, which is a simple physical mixture comprising about 68% by weight of LiFePO₄, about 30% by weight of LiAl_{0.05}Ni_{0.8}Co_{0.15}O₂, and about 1.2% carbon. The results are summarized in Table 1.

TABLE 1

| | | Cycle | Capacity |
|---|---|---|---|
| Negative | Positive Material | Number | loss |
| MCMB^{a} | Agglomerated Particle I | 310 | 0.0% |
| MCMB^{a} | Agglomerated Particle I | 373 | 1.2% |
| Synthetic graphite | Agglomerated Particle I | 353 | 3.3% |
| MCMB^{a} | Agglomerated Particle II | 308 | 4.4% |
| Synthetic graphite | Agglomerated Particle II | 304 | 1.5% |
| MCMB^{b} | Physical Mixture II | 330 | 12.4% |
| MCMB^{a} | Physical Mixture II | 123 | 10.6% |
| MCMB^{a} | Physical Mixture II | 119 | 9.5% |
| MCMB^{a} | Physical Mixture II | 119 | 8.7% |
| MCMB^{a} | Physical Mixture II | 119 | 7.3% |

^{a}Mesocarbon microbead and SBR
^{b}Mesocarbon microbead and a non-SBR binder.

The cycle life of the cells was determined by charging the cells to 4V at 0.7 C, resting for 10 min, and then discharging to 2.2 V at 0.5 C. The capacity loss was calculated by the equation: (initial capacity−capacity at the last cycle)/initial cell capacity.

### Example 8

### Preparation of Electroactive Agglomerated Particles

A uniform suspension of LiFePO₄, LiAl_{0.05}Ni_{0.8}Co_{0.15}O₂, carbon nanoparticles, and coke in a solvent (e.g., NMP) is hot spray dried to form agglomerated particles. The agglomerated particles are further heat treated at an elevated temperature (e.g., about 300° C.) to form electroactive agglomerated particles, which are then crushed into predetermined particle sizes (e.g., in the range of about 1 to about 50 μm).

### Example 9

### Preparation of Coated Electroactive Particles

The agglomerated particles from one of Examples 3 to 8 are sprayed with a solution of a polyamideimide (e.g., TORLON® AI-30, TORLON® AI-50, TORLON® 4000, or TORLON® 4203L) in a solvent (e.g., N-methylpyrrolidinone). The agglomerated particles are further cured at an elevated temperature (e.g., about 300° C.) to form coated electroactive particles. The coated electroactive particles are then crushed into predetermined particle sizes (e.g., in the range of about 1 to about 50 μm).

### Example 10

### Preparation of Coated Electroactive Particles

The agglomerated particles from one of Examples 3 to 8 are sprayed with a solution of precursors of a polyimide (e.g., U-VARNISH®) in a solvent (e.g., N-methylpyrrolidinone). The wet agglomerated particles are further cured at an elevated temperature (e.g., about 300° C.) to form coated electroactive particles. The coated electroactive particles are then crushed into predetermined particle sizes (e.g., in the range of about 1 to about 50 μm).

### Example 11

### Preparation of Coated Electroactive Particles

The agglomerated particles from one of Examples 3 to 8 are added to a solution of a polyamideimide (e.g., TORLON® AI-30, TORLON® AI-50, TORLON® 4000, or TORLON® 4203L) in a solvent (e.g., N-methylpyrrolidinone) to form a uniform suspension, which is hot spray dried to form coated electroactive particles. The coated electroactive particles are further cured at an elevated temperature (e.g., about 300° C.), and then crushed into predetermined particle sizes (e.g., in the range of about 1 to about 50 μm).

### Example 12

### Preparation of Coated Electroactive Particles

The agglomerated particles from one of Examples 3 to 8 are added to a solution of precursors of a polyimide (e.g., U-VARNISH®) in a solvent (e.g., N-methylpyrrolidinone) to form a uniform suspension, which is hot spray dried to form coated electroactive particles. The coated electroactive particles are further cured at an elevated temperature (e.g., about 300° C.), and then crushed into predetermined particle sizes (e.g., in the range of about 1 to about 50 μm).

### Example 13

### Preparation of Coated Electroactive Particles

A uniform suspension of LiFePO₄ nanoparticles, doped LiNiO₂ (e.g., LiAl_{0.05}Ni_{0.8}Co_{0.15}O₂) nanoparticles, carbon nanoparticles, and coke in a solvent (e.g., N-methylpyrrolidinone) that contains a polyamideimide (e.g., TORLON® AI-30, TORLON® AI-50, TORLON® 4000, or TORLON® 4203L) is hot spray dried to form coated electroactive particles. The coated electroactive particles are further cured at an elevated temperature (e.g., about 300° C.), and then crushed into predetermined particle sizes (e.g., in the range of about 1 to about 50 μm).

### Example 14

### Preparation of Coated Electroactive Particles

A uniform suspension of LiFePO₄ nanoparticles, doped LiNiO₂ (e.g., LiAl_{0.05}Ni_{0.8}Co_{0.15}O₂) nanoparticles, carbon nanoparticles, and coke in a solvent (e.g., N-methylpyrrolidinone) that contains precursors of a polyimide (e.g., U-VARNISH®) is hot spray dried to form coated electroactive particles. The coated electroactive particles are further cured at an elevated temperature (e.g., about 300° C.), and then crushed into predetermined particle sizes (e.g., in the range of about 1 to about 50 μm).

### Example 15

### Preparation of Coated Electroactive Particles

A uniform suspension of Si nanoparticles in a solvent (e.g., N-methylpyrrolidinone) that contains a polyamideimide (e.g., TORLON® AI-30, TORLON® AI-50, TORLON® 4000, or TORLON® 4203L) is hot spray dried to form coated electroactive particles. The coated electroactive particles are further cured at an elevated temperature (e.g., about 300° C.), and then ground into predetermined particle sizes (e.g., in the range of about 1 to about 50 μm).

### Example 16

### Preparation of Coated Electroactive Particles

A uniform suspension of Si nanoparticles in a solvent (e.g., N-methylpyrrolidinone) that contains precursors of a polyimide (e.g., U-VARNISH) is hot spray dried to form coated electroactive particles. The coated electroactive particles are further cured at an elevated temperature (e.g., about 300° C.), and then ground into predetermined particle sizes (e.g., in the range of about 1 to about 50 μm).

### Example 17

### Preparation of Coated Electroactive Particles

A uniform suspension of Si nanoparticles and carbon nanoparticles in a solvent (e.g., N-methylpyrrolidinone) that contains a polyamideimide (e.g., TORLON® AI-30, TORLON® AI-50, TORLON® 4000, or TORLON® 4203L) is hot spray dried to form coated electroactive particles. The coated electroactive particles are further cured at an elevated temperature (e.g., about 300° C.), and then ground into predetermined particle sizes (e.g., in the range of about 1 to about 50 μm).

### Example 18

### Preparation of Coated Electroactive Particles

A uniform suspension of Si nanoparticles and carbon nanoparticles in a solvent (e.g., N-methylpyrrolidinone) that contains precursors of a polyimide (e.g., U-VARNISH®) is hot spray dried to form coated electroactive particles. The coated electroactive particles are further cured at an elevated temperature (e.g., about 300° C.), and then ground into predetermined particle sizes (e.g., in the range of about 1 to about 50 μm).

### Example 19

### Preparation of Coated Electroactive Particles

A uniform suspension of Si nanoparticles and carbon nanoparticles in a solvent (e.g., water) that contains precursors of a carboxymethyl cellulose (CMC) is hot spray dried to form coated electroactive particles. The coated electroactive particles are further cured at an elevated temperature (e.g., about 200° C.), and then ground into predetermined particle sizes (e.g., in the range of about 1 to about 50 μm).

### Example 20

### Preparation of Coated Electroactive Particles

A uniform suspension of Si nanoparticles and carbon nanoparticles in a solvent (e.g., dimethylacetate) that contains precursors of a polysulfone is hot spray dried to form coated electroactive particles. The coated electroactive particles are further cured at an elevated temperature (e.g., about 300° C.), and then ground into predetermined particle sizes (e.g., in the range of about 1 to about 50 μm).

The examples set forth above are provided to give those of ordinary skill in the art with a complete disclosure and description of how to make and use the claimed embodiments, and are not intended to limit the scope of what is disclosed herein. Modifications that are obvious to persons of skill in the art are intended to be within the scope of the following claims. All publications, patents, and patent applications cited in this specification are incorporated herein by reference as if each such publication, patent or patent application were specifically and individually indicated to be incorporated herein by reference.

1-15. (canceled)

16. A coated electroactive particle, comprising (i) an electroactive agglomerated particle that comprises at least two subparticles of an electroactive material and optionally a binder; and (ii) an organic polymer; wherein the outside surface of the electroactive agglomerated particle is coated with the organic polymer; wherein the electroactive material comprises silicon monoxide; and wherein the organic polymer comprises a polyamideimide or polyimide.

17. The coated electroactive particle of claim 16, wherein the electroactive agglomerated particle further comprises at least one diluent subparticle.

18. (canceled)

19. The coated electroactive particle of claim 16, wherein the organic polymer is a crosslinkable polyamideimide or polyimide.

20. The coated electroactive particle of claim 16, wherein the organic polymer is TORLON AI-30, TORLON AI-50, TORLON 4000, or TORLON 4203L.

21. The coated electroactive particle of claim 16, wherein the organic polymer is formed from precursors of the polymer on the surface of the electroactive agglomerated particle.

22. The coated electroactive particle of claim 21, wherein the precursors are U-VARNISH.

23-24. (canceled)

25. The coated electroactive particle of claim 16, wherein the subparticles of the electroactive material have an averaged particle size from about 1 to about 500 nm.

26. The coated electroactive particle of claim 17, wherein the diluent subparticle is a carbon subparticle.

27. The coated electroactive particle of claim 17, wherein the diluent subparticle has an averaged particle size from about 10 nm to about 10 μm.

28. The coated electroactive particle of claim 16, wherein the volume change of the coated electroactive particle during a charging/discharging cycle is no more than about 200%.

29. An electrode comprising the coated electroactive particle of claim 16, a current collector, and optionally a binder.

30. The electrode of claim 29, wherein the electrode is an anode.

31. A lithium ion battery comprising the anode of claim 30, a cathode, and an electrolyte.

32. The lithium ion battery of claim 31, wherein the cathode comprises an electroactive agglomerated particle that comprises subparticles of a first electroactive material and subparticles of a second electroactive material.

33-34. (canceled)

35. The coated electroactive particle of claim 16, wherein the electroactive agglomerated particle has an average particle size ranging from about 0.1 to about 100 μm.

36. The coated electroactive particle of claim 16, wherein the binder comprises a second organic polymer.

37. The coated electroactive particle of claim 36, wherein the second organic polymer is formed from a crosslinkable organic polymer.

38. The coated electroactive particle of claim 36, wherein the second organic polymer is a crosslinkable polyamideimide or polyimide.
